(19) United States
(12) Patent Application Publication
(10) Pub. No.: US 2026/0298817 A1
(43) Pub. Date: Oct. 1, 2026

(54) High-Dynamic-Range Laser Absorption Spectrometer

(71) Applicant: California Institute of Technology, Pasadena, CA (US)

(72) Inventors: Ryan M. Briggs, Altadena, CA (US); Mathieu Fradet, Pasadena, CA (US); Nicholas R. Tallarida, Pasadena, CA (US); Lance E. Christensen, Baldwin Park, CA (US)

(73) Assignee: California Institute of Technology, Pasadena, CA (US)

(21) Appl. No.: 19/631,528

(22) Filed: Mar. 27, 2026

Related U.S. Application Data
(60) Provisional application No. 63/778,813, filed on Mar. 27, 2025.

(51) Int. Cl. G01N 21/39; G01N 21/03

(52) U.S. Cl. CPC G01N 21/39; G01N 21/031

(57) ABSTRACT

A sensor for analyzing gas compositions is described, as well as methods of assembly and use thereof. The sensor is a spectroscopic sensor, that relies on propagating laser light through two optical channels of drastically different pathlengths and a Fabry-Perot silica etalon reference to probe a gaseous sample such as to determine a volume mixing ratio for an impurity present in the gaseous sample with a large dynamic range of part-per-million levels to saturated (one to several percent by volume) levels with high precision.

### CROSS-REFERENCE TO RELATED APPLICATIONS

The current application claims the benefit of and priority under 35 U.S.C. § 119 (e) to U.S. Provisional Patent Application No. 63/778,813, entitled “High-Dynamic-Range Laser Absorption Spectrometer for Detection of Water in Oxygen Gas”, filed Mar. 27, 2025, the disclosure of which is incorporated herein by reference in its entirety for all purposes.

### STATEMENT REGARDING FEDERALLY SPONSORED RESEARCH

This invention was made with Government support under Grant No. 80NMO0018D0004 awarded by NASA (JPL). The Government has certain rights in this invention.

### FIELD OF THE INVENTION

The invention is generally directed to a sensor for analyzing gaseous compositions.

### BACKGROUND OF THE INVENTION

There exists a wide-ranging need for sensors for composition analysis of gases, such as propellant gases, or gases used in various industrial processes, that can detect miniscule amounts of gas impurities. As one example, high purity oxygen gas is essential for many processes, including medical treatments, industrial processes, combustion, and aerospace applications, yet it is particularly difficult to analyze because it is very corrosive, including towards any potential sensor components, such as, for example, electronic components, and also enhances the flammability of combustible materials. Therefore, there is a need for sensors for detecting gaseous impurities, such as water vapor, in oxygen gas.

### SUMMARY OF THE INVENTION

Various embodiments are directed to a sensor for analyzing gas compositions including:
an analysis cell, characterized by a cell volume and further including:
   a cell temperature sensor;
   a cell pressure sensor;
   a sample inlet, including a sample inlet fitting, for delivering a sample of a gas to be analyzed into the analysis cell; and
   a sample outlet, including a sample outlet fitting, for flowing the sample of the gas out of the analysis cell;
a plurality of mirrors for forming optical channels;
at least one sapphire wedge window;
a foreoptics compartment, characterized by a foreoptics volume, wherein the foreoptics compartment is adjacent to, but is isolated from, including via the at least one sapphire wedge window, the analysis cell; wherein the foreoptics compartment further includes:
   a foreoptics temperature sensor;
   a foreoptics pressure sensor; and
   optical components, including:
      a laser source,
      a plurality of beamsplitters,
      a plurality of photodetectors, and
      a reference etalon;
   wherein the foreoptics volume is sealed and evacuated, including isolated from the cell volume using O-ring seals on the at least one sapphire wedge windows and the plurality of mirrors; and
an electronics compartment including electronics, and further including control electronics;
such that, a laser emission, characterized by a laser wavelength, produced by the laser source is routed by the plurality of beam splitters and the plurality of mirrors through three optical channels: a long-pathlength channel and a short-pathlength channel within the analysis cell including the sample, and the reference etalon.

In various such embodiments, the plurality of mirrors includes three mirrors: M1, M2, and M3, such that M1 and M2 form the long-pathlength channel, while M3 forms the short-pathlength channel.

In still various such embodiments, the long-pathlength channel is of a multi-pass Herriott cell optical configuration.

In still yet various embodiments, the long-pathlength channel is a 62-pass optical path in the Herriott cell configuration with a total optical pathlength of 9.6 m.

In yet still various such embodiments, the reference etalon is a reference selected from the group including: a Fabry-Perot silica etalon and a sealed cell containing a known reference gas.

In yet various such embodiments, the laser source is a tunable single-frequency semiconductor laser.

In various such embodiments, the laser source is a 2.6 μm-wavelength laser.

Various other embodiments are directed to a method for analyzing gas compositions including:
providing a sensor including:
   an analysis cell, characterized by a cell volume and further including:
      a cell temperature sensor;
      a cell pressure sensor;
      a sample inlet, including a sample inlet fitting, for delivering a sample of a gas to be analyzed into the analysis cell; and
      a sample outlet, including a sample outlet fitting, for flowing the sample of the gas out of the analysis cell;
   a plurality of mirrors for forming optical channels;
   at least one sapphire wedge window;
   a foreoptics compartment, characterized by a foreoptics volume, wherein the foreoptics compartment is adjacent to, but is isolate from, including via the at least one sapphire wedge window, the analysis cell; wherein the foreoptics compartment further includes:
      a foreoptics temperature sensor;
      a foreoptics pressure sensor; and
      optical components, including:
         a laser source,
         a plurality of beamsplitters,
         a plurality of photodetectors, and
         a reference etalon;
         wherein the foreoptics volume is sealed and evacuated, including isolated from the cell volume using O-ring seals on the at least one sapphire wedge window and the plurality of mirrors; and
   an electronics compartment including electronics, and further including control electronics;
   such that, a laser emission, characterized by a laser wavelength, produced by the laser source is routed by the plurality of beam splitters and the plurality of mirrors through three optical channels: a long-pathlength channel and a short-pathlength channel within the analysis cell including the sample, and the reference etalon;
providing the sample including a second gas to be analyzed for a presence and a concentration of a first gas, wherein the first gas is characterized by a first absorption line, and flowing the sample into the analysis cell;
propagating the laser emission, wherein the laser wavelength is adjusted to probe the first absorption line, through the three optical channels to profile the sample for the first absorption line
to determine a volume mixing ratio for the first gas in the sample.

In various such embodiments, the first gas is a molecule selected from the group including: H₂O, CO, CO₂, CH₄, and another gaseous compound with a known absorption line or lines.

In still various such embodiments, the second gas is N₂ or O₂.

In still yet various embodiments, the plurality of mirrors includes three mirrors: M1, M2, and M3, such that M1 and M2 form the long-pathlength channel, while M3 forms the short-pathlength channel.

In yet still various such embodiments, the long-pathlength channel is of a multi-pass Herriott cell optical configuration.

In yet various such embodiments, wherein the first gas is H₂O and the second gas is O₂, the long-pathlength channel is a 62-pass optical path in the Herriott cell configuration with a total optical pathlength of 9.6 m.

In various such embodiments, the laser source is a tunable single-frequency semiconductor laser.

In still various such embodiments, wherein the first gas is H₂O, the laser wavelength is a 2.6 μm.

In yet still various such embodiments, the reference etalon is a reference selected from the group including: a Fabry-Perot silica etalon and a sealed cell containing a known reference gas.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which form a part of this disclosure.

### BRIEF DESCRIPTION OF THE DRAWINGS

These and other features and advantages of the present invention will be better understood by reference to the following detailed description when considered in conjunction with the accompanying data and figures, wherein:

FIGS. 1A and 1B schematically illustrate the sensor and its components, wherein FIG. 1B, in particular, illustrates optomechanical design and components in greater detail, in accordance with embodiments of the application.

FIG. 2 provides common mid-infrared molecular absorption lines, according to prior art.

FIG. 3 schematically illustrates the optical channels of the sensor, in accordance with embodiments of the application.

FIG. 4 provides exemplary data illustrating principles of operation for the sensor, in accordance with embodiments of the application.

FIGS. 5A and 5B provide the gas flow diagram for the sensor and illustrate the pressure and temperature sensing components, wherein FIG. 5A schematically illustrates the separation between the analysis cell and the foreoptics compartment; while FIG. 5B shows the installed pressure sensor, e.g., media-isolated pressure sensor (0 to 6 bar) for the analysis cell, in accordance with embodiments of the application.

FIGS. 6A and 6B provide photographs and schematics illustrating elements of the analysis cell and sample inlet and outlet fittings, wherein FIG. 6A shows the analysis cell with the sample outlet and sample inlet gas fittings (prior to mirror assembly, wherein the analysis cell is shown on a stand); while FIG. 6B illustrates in greater detail the sample inlet fitting (top), wherein the sample inlet fitting is a stainless ¼″ VCR gland orbital welded to stainless O-ring boss fitting, and the sample outlet fitting (bottom), wherein the sample outlet fitting is a welded bi-metallic ¼″ VCR gland, in accordance with embodiments of the application.

FIG. 7 illustrates mirror components of the sensor, wherein FIG. 7, top, schematically illustrates formation of the long- and short-pathlength channels with mirrors M1, M2, and M3; FIG. 7, middle left, provides a photograph of M1, M2, and M3; FIG. 7, middle right, provides a photograph of M2 attached to a flange; and FIG. 7, bottom, provides a photograph of M1 prior to stacking onto the sealed sapphire wedge window, in accordance with embodiments of the application.

FIG. 8 schematically illustrates the Herriott cell design in accordance with embodiments of the application.

FIGS. 9A through 9C illustrate the laser, wherein FIG. 9A illustrates the laser source; FIG. 9B illustrates the 2.6 μm fiber-pigtailed laser package; and FIG. 9C provides data showing typical emission vs. injection current for the laser (top), and the laser's wavelength before and after environmental testing (as measured by FTIR), in accordance with embodiments of the application.

FIGS. 10A through 10B illustrate the laser collimator, wherein FIG. 10A provides photographs of a mount (top) and a fiber collimator (here, characterized by 1.2 mm beam waist diameter, 0.13° divergence); while FIG. 10B shows the corresponding beam profiles at 15 cm prior to environmental tests (top) and post environmental tests (bottom), in accordance with embodiments of the application.

FIG. 11 illustrates the beamsplitters and optical throughput of the sensor, in accordance with embodiments of the application.

FIGS. 12A and 12B illustrate the sapphire wedge windows, wherein FIG. 12A illustrates the sapphire wedge windows with a schematic showing the window geometry (0.5 in. diameter) (top), and a photograph showing the sapphire wedge windows sealed between silicone O-rings (bottom); and FIG. 12B illustrates reflectance properties of the AR coating, in accordance with embodiments of the application.

FIGS. 13A and 13B illustrate the photodetectors, wherein FIG. 13A shows the HgCdTe photovoltaic detector with the immersion lens (top), and photodetector/lens assembly (bottom); while FIG. 13B illustrates the photodetectors' responsivity, in accordance with embodiments of the application.

FIG. 14 illustrates the reference Fabry-Perot etalon, including with data showing calculated etalon transmission over the laser tuning range: 1 cm length, 60% surface reflectivity, in accordance with embodiments of the application.

FIGS. 15A and 15B illustrate thermal expansion effects on the long-pathlength channel/Herriott cell, wherein FIG. 15A shows calculated displacement due to 35° C. temperature increase, while FIG. 15B schematically illustrates the laser beam displacement due to thermal expansion, in accordance with embodiments of the application.

FIGS. 16A through 16D illustrate various aspects of the electronics utilized by the sensor, wherein, more specifically, FIG. 16A provides the electronics block diagram; FIG. 16B provides a diagram for host interface with the sensor; FIG. 16C provides a power diagram for the sensor; and FIG. 16D provides an isolation/grounding diagram for the sensor, in accordance with embodiments of the application.

FIG. 17 provides an example illustrating a typical power budget for the sensor (top) and provides data showing measured current for the sensor at turn on (bottom), in accordance with embodiments of the application.

FIGS. 18A and 18B illustrate data output by the sensor, wherein FIG. 18A shows data output for an analyzed sample of moderate humidity, wherein the sample is air with water concentration of 0.3% by volume; and FIG. 18B shows data output for an analyzed sample of low humidity, wherein the sample is laboratory garden nitrogen gas with water concentration of 0.7 ppmv, in accordance with embodiments of the application.

FIG. 19 provides data illustrating the lower detection limit of the sensor over a pressure and temperature range, in accordance with embodiments of the application.

FIGS. 20A through 20C illustrate various aspects of the sensor assembly and pre-alignment, wherein FIG. 20A provides a photograph of the foreoptics components ready for pre-alignment; FIG. 20B provides a photograph of the analysis cell modified for pre-alignment; and FIG. 20C illustrates alignment of the long-pathlength channel with red laser, in accordance with embodiments of the application.

FIG. 21 provides data illustrating pressure dependence of the long-pathlength, short-pathlength, and etalon channels, in accordance with embodiments of the application.

FIGS. 22A and 22B illustrate an issue (with resolution) wherein water vapor is present in a laser package of an assembled LIRA instrument, wherein FIG. 22A shows absorption data for the sensor assembled with an as-packaged laser, wherein the data implies 2 ppmv H₂O in the long-path and 200 ppmv H₂O in the short path (top); and absorption data for the same sensor with the laser package vented, wherein the data shows 6 ppmv H₂O in the long path and no detectable H₂O in the short path; and wherein FIG. 22B shows the vented with a hole laser package, in accordance with embodiments of the application.

FIG. 23 provides photographs to illustrate the sensor at various stages of assembly, wherein the photograph on top shows the foreoptics compartment with staking epoxy following environmental testing, while the photograph on bottom shows several fully assembled LIRA instruments, in accordance with embodiments of the application.

FIG. 24 illustrates with a photograph the Low Humidity Generator set-up used in the sensor validation analysis, in accordance with embodiments of the application.

FIGS. 25A and 25B provide data illustrating the low humidity performance of two different models of the sensor, wherein FIG. 25A provides data showing H₂O vs. pressure/temperature dependence (top), data showing H₂O concentration vs. flow rate dependence (middle), and data illustrating long-term stability of the sensor (bottom); while FIG. 25B provides data showing measured H₂O vs. pressure at 25° C. dependence (top), data showing H₂O concentration vs. pressure/temperature dependence (middle); and data showing measured H₂O with Low Humidity Generator set to 0.15 ppmv, in accordance with embodiments of the application.

FIG. 26 provides data demonstrating dynamic range and analog output of the sensor, including data showing measured H₂O concentration from 0.3 to 3,000 ppmv (top); data showing measured H₂O concentration vs. pressure dependence at 3,000 ppmv (middle); and analog output transfer function and measured voltage from 0.3 to 3,000 ppmv, in accordance with embodiments of the application.

FIGS. 27A and 27B provide data illustrating gas composition dependence of the sensor, wherein FIG. 27A provides absorbance spectra collected with 50 ppmv H₂O, and FIG. 27B illustrates dependence of line broadening coefficient on pressure, in accordance with embodiments of the application.

FIGS. 28A and 28B illustrate the effect of broadening coefficient, wherein FIG. 28A tabulates modeled error in H₂O concentration using γ=0.0929 cm⁻¹/atm for fitting; while FIG. 28B provides modeled 50 ppmv spectra fit with γ=0.0929 cm⁻¹/atm, in accordance with embodiments of the application.

### DETAILED DISCLOSURE

Turning now to the schemes, images, and data, a sensor for analyzing gas compositions is described, as well as a method of assembly and use thereof. In many embodiments, the sensor is a spectroscopic sensor. In many such embodiments, the sensor relies on propagating laser light through two optical channels of drastically different pathlengths and a reference channel to probe a gaseous sample such as to determine a volume mixing ratio (VMR) for an expected impurity present in the gaseous sample. In many embodiments, the sensor determines the VMR within a large dynamic range of part-per-million levels to saturated (one to several percent by volume) levels with high precision. In many embodiments, the sensor comprises: an analysis cell, characterized by a cell volume; a plurality of mirrors for forming optical channels; at least one sapphire wedge window; a foreoptics compartment, characterized by a foreoptics volume, wherein the foreoptics compartment is adjacent to, but is isolated from (including via the at least one sapphire wedge window) the analysis cell; and an electronics compartment comprising electronics, and further comprising control electronics. In many embodiments, the analysis cell further comprises: a cell temperature sensor; a cell pressure sensor; a sample inlet, comprising a sample inlet fitting, for delivering a sample of a gas to be analyzed into the analysis cell; and a sample outlet, comprising a sample outlet fitting, for flowing the sample of the gas out of the analysis cell. Furthermore, in many embodiments, the foreoptics compartment further comprises: a foreoptics temperature sensor; a foreoptics pressure sensor; and optical components. In many such embodiments, the optical components within the foreoptics compartment comprise: a laser source, a plurality of beamsplitters, a plurality of photodetectors, and a reference etalon. In addition, in many embodiments, the foreoptics volume is sealed and evacuated, including isolated from the cell volume using O-ring seals on the at least one sapphire wedge windows and the plurality of mirrors. Accordingly, in many embodiments, the sensor's components allow for a laser emission, characterized by a laser wavelength, produced by the laser source to be routed by the plurality of beam splitters and the plurality of mirrors through three optical channels: a long-pathlength channel and a short-pathlength channel within the analysis cell comprising the sample, and the reference etalon. In many such embodiments, the plurality of mirrors comprises three mirrors: M1, M2, and M3, such that M1 and M2 form the long-pathlength channel, while M3 forms the short-pathlength channel. Furthermore, in many embodiments, the long-pathlength channel is of a multi-pass Herriott cell optical configuration. In many embodiments, the reference etalon is a reference selected from the group comprising: a Fabry-Perot silica etalon and a sealed cell containing a known reference gas. In many embodiments, the laser source is a tunable single-frequency semiconductor laser.

Many embodiments are directed to a method utilizing the sensor for analyzing gas compositions comprising flowing the sample comprising a second gas to be analyzed for a presence and a concentration of a first gas, wherein the first gas is characterized by a first absorption line, into the analysis cell of the sensor, and propagating the laser emission, wherein the laser wavelength is adjusted to probe the first absorption line, through the three optical channels to profile the sample for the first absorption line, to determine a volume mixing ratio for the first gas in the sample. In many embodiments, the first gas is a molecule selected from the group comprising: H₂O, CO, CO₂, CH₄, and another gaseous compound with a known absorption line or lines. In many embodiments, the second gas is N₂ or O₂. In many embodiments, especially wherein the first gas is H₂O, the long-pathlength channel is a 62-pass optical path in the Herriott cell configuration with a total optical pathlength of 9.6 m. In many embodiments, wherein the first gas is H₂O, the laser wavelength is a 2.6 μm. It will be understood that the embodiments of the invention described herein are not intended to be exhaustive or to limit the invention to precise forms disclosed. Rather, the embodiments selected for description have been chosen to enable one skilled in the art to practice the invention.

An important need of space and extraterrestrial exploration is a sensor that can accurately detect water vapor impurities at low levels, reliably operate within a pure oxygen environment, and, in general, survive the environments expected with spaceflight and space exploration. However, currently available sensing technologies do not meet these requirements. For example, electrochemical sensors have been used in spaceflight applications, however such sensors are not compatible with pure oxygen, due to reactivity of the electrolyte and related electrical components. As other examples, piezoelectric surface acoustic wave sensors and chilled mirror hygrometers have not been demonstrated in a flight-like configuration, and, also, are generally only used with inert gases due to potential reactivity of internal components that may contact the analyzed gas.

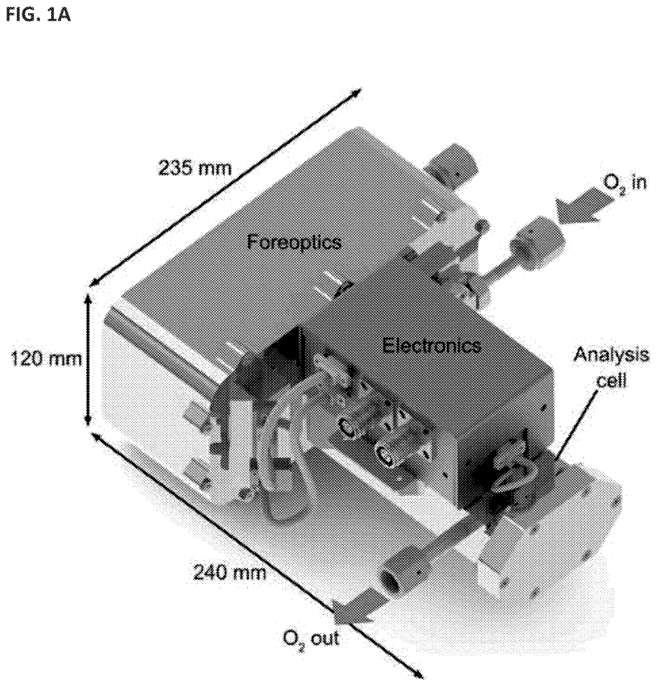

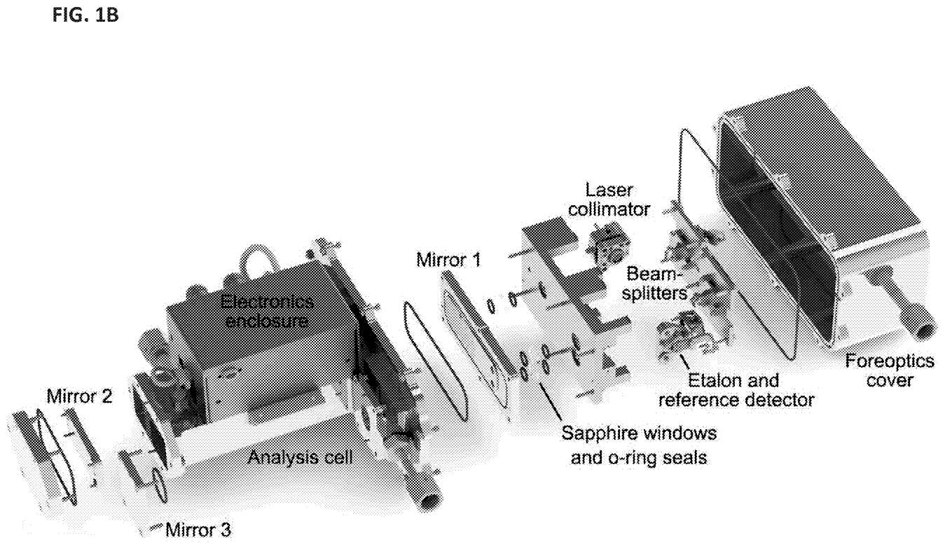

This application is directed to embodiments of a sensor for measuring gas compositions and methods of use thereof. In many embodiments, the sensor is a Laser In situ Resource Analyzer (LIRA) instrument. More specifically, in many embodiments, the sensor comprises a spectrometer capable of measuring a volume mixing ratio (VMR) of a first gas in a second gas, wherein the second gas is a balance or bulk gas. In many embodiments, the spectrometer is a laser absorption spectrometer. In many such embodiments, the spectrometer comprises: an analysis cell, characterized by a cell volume, and further comprising a cell temperature sensor and a cell pressure sensor; a sample inlet, comprising a sample inlet fitting, for delivering a sample of a gas to be analyzed into the analysis cell; a sample outlet, comprising a sample outlet fitting, for flowing the sample of the gas out of the analysis cell; a plurality of mirrors; a foreoptics compartment, comprising a foreoptics temperature sensor, a foreoptics pressure sensor, and optical components, including a laser source, beamsplitters, photodetectors, and a reference etalon; and an electronics compartment, comprising electronics, including control electronics, such as, for example, shown in FIGS. 1A and 1B.

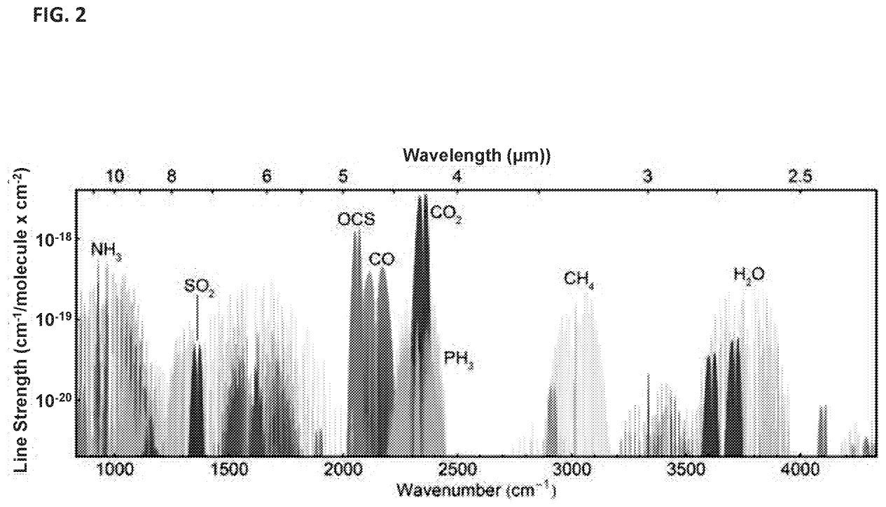

Furthermore, in many embodiments, the spectrometer comprises the laser source providing a laser emission/light, characterized by a laser wavelength, such that the spectrometer relies on propagating the laser light of the laser wavelength over a known pathlength through the analysis cell containing the sample to spectral resolve the absorption line of a first gas (a first absorption line). In many embodiments, the laser source is a tunable single-frequency semiconductor laser. In many embodiments, the laser source is a single-mode distributed feedback chip in a fiber-coupled package comprising an integrated thermoelectric cooler for temperature stabilization. In many embodiments, the laser wavelength is selected to be close to the first absorption line. For example, in some embodiments, especially wherein the first gas is water vapor, the laser source emits around the wavelength of a strong H₂O absorption line at 2605 nm (FIG. 2) and has at least ±1 nm tunability using injection current tuning. Furthermore, FIG. 2 provides several examples of common mid-infrared molecular absorption lines for various gases, including the water's absorption lines centered near 2.6 μm wavelength. Accordingly, in many embodiments, the first gas is a gaseous molecule, characterized by the first absorption line, selected from the group comprising of: water vapor (H₂O), CO, CO₂, CH₄, and another gaseous compound with a known absorption line or lines. In many such embodiments, the laser wavelength is selected to correspond to the first absorption line of choice or need. In many embodiments, the second/balance gas is nitrogen (N₂) or oxygen (O₂) gas.

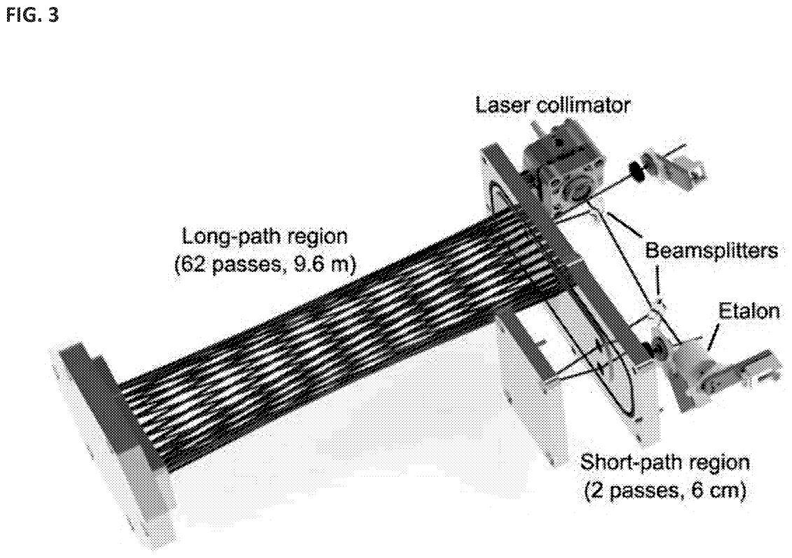

More specifically, in many embodiments, the laser emission afforded by the laser source is routed by the beamsplitters through three optical channels: 1) a long-pathlength channel, 2) a short-pathlength channel, and 3) a reference channel (the reference etalon), as schematically illustrated in FIG. 3. As such, in many embodiments, the beamsplitters are used to create two optical paths for analysis and a separate path for a spectroscopic reference. It should be noted here that, each channel of the three optical channels is defined by its total pathlength, wherein the long- and the short-pathlength channels are necessarily partly in the foreoptics compartment and partly in the analysis cell. However, in many embodiments, the foreoptics compartment is evacuated, such as to avoid any absorption lines in the foreoptics compartment. As such, in many embodiments, the long- and short-pathlength channels are defined by the laser propagation path only in the analysis (i.e., sample) cell. Furthermore, in many embodiments, the reference channel is defined by the laser light transmission through the reference etalon. In some such embodiments, the reference etalon is a sealed cell containing a known gas.

Furthermore, in many embodiments, the long-pathlength channel is achieved by using a multi-pass Herriott cell optical configuration (FIG. 3). In many such embodiments, this configuration allows to achieve a long optical pathlength within a relatively small analysis cell length. Moreover, in many embodiments, the reference channel enables continuous monitoring of characteristics of the laser wavelength tuning. More specifically, in many embodiments, the etalon is used as an in situ spectroscopic reference, in contrast to conventional laser absorption spectrometers relying on a gas-filled cell implements for reference measurements. In many embodiments, the etalon is a Fabry-Perot etalon. Accordingly, in many embodiments, the sensor relies on a single laser of the laser wavelength that matches the first absorption line to probe all three optical channels. In many embodiments, the sensor affords direct absorption measurements with nonlinear spectral fitting.

Even more specifically, in many embodiments, two beamsplitters are used by the sensor to achieve two analysis channels with different pathlengths, in addition to the reference channel. In many embodiments, the difference in pathlengths between the long- and short-pathlength channels is as large as two orders of magnitude, or more. As such, in many embodiments, the pathlengths difference drastically increases the dynamic range of the sensor's absorption sensitivity. Accordingly, in many such embodiments, the long- and short-pathlength channels, together, enable a large VMR dynamic range for the first gas. In many embodiments, the large VMR range is a range from part-per-million levels to saturated levels, wherein a saturated level is one to several percent first gas in the second gas by volume. In some embodiments, the LIRA instrument described herein, affords an accuracy from less than 1 ppmv water to more than 10,000 ppmv water (1% by volume) in oxygen balance.

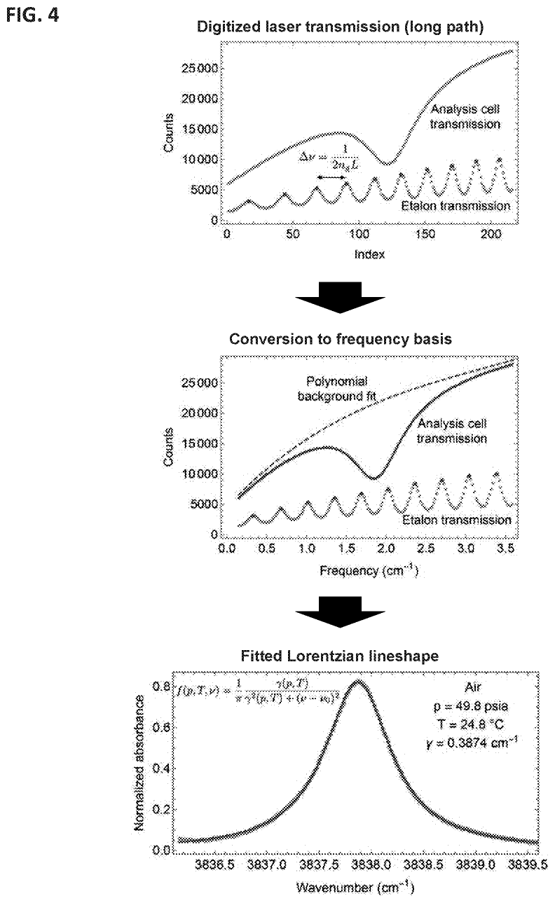

To this end, FIG. 4 illustrates the principles of operation of the sensor of many embodiments. It should be noted here that, although, for illustrative purposes, the analysis example provided in FIG. 4 shows data afforded by the long-pathlength channel of the sensor only, for a sample comprising 50 ppmv H₂O (the first gas) in air (the balance gas, at p=49.8 psia, T=24.8° C., and γ=0.3874 cm⁻¹), the same principles of operation of many embodiments apply to the short-pathlength channel and to various other analytes. Accordingly, in many embodiments, the laser wavelength is tuned linearly with current across the target/first absorption line at vo (wherein, for example, vo=3837.87 cm⁻¹ for H₂O). In many embodiments, the Fabry-Perot etalon characterized by an etalon length (L) and a group index (ng) establishes frequency scale:

$$Δν = \frac{1}{2 {n}_{g} L}$$

In addition, in many embodiments line strength(S) and pressure broadening coefficient (γ) are obtained from the HITRAN database (see, I. E. Gordon, et al., “The HITRAN2020 molecular spectroscopic database”, J. Quant. Spectrosc. Radiat. Transfer 277, 107949 (2022), the disclosure of which is incorporated herein by reference). As such, in many embodiments, provided the known fixed propagation length (I) (i.e., the length of the optical channel) and the measured within the analysis cell pressure and temperature, of the sample, as well as the measured absorbance (A), the concentration of the first gas in the sample is calculated via the following equations, assuming the absorption lineshape, f, is dominated by pressure broadening:

$$f ( p , T , ν ) = \frac{1}{π} \frac{γ ( p , T )}{{γ}^{2} ( p , T ) + {( ν - {ν}_{0} )}^{2}}$$

$$A \approx cl S ( T ) \int f ( p , T , ν ) d ν$$

It should be noted here that, in some embodiments, the sensor is used to measure an unknown pressure broadening coefficient.

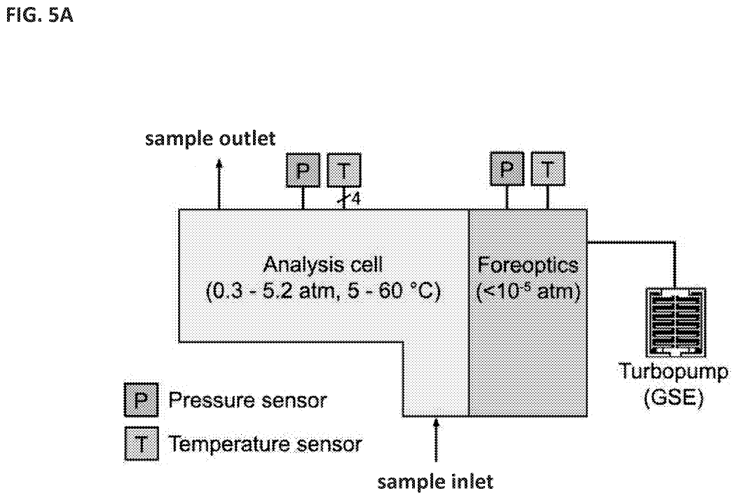

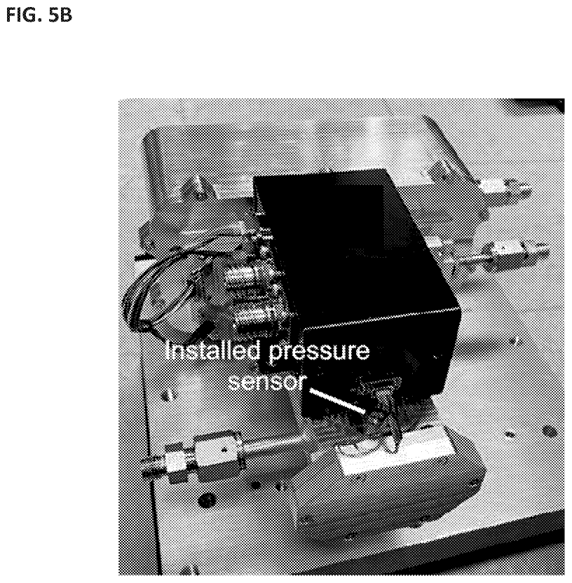

More specifically, in many embodiments, the analysis cell comprises a sealed cell that contains the sample of the gas to be analyzed (FIG. 5A). In many embodiments, especially wherein the balance gas is oxygen, the analysis cell, and the cell volume in particular, are designed to be compatible with and operate in a pure O₂ environment over the required pressure and temperature range. To this end, in many embodiments, the analysis cell interfaces to input and output gas lines (via the sample inlet and sample outlet, respectively), using standard gas fittings. In addition, in many embodiments, the sensor's seals and coatings, as well as bounding operating conditions, are carefully chosen for the analysis cell, and the overall sensor, to be resistant to oxidation by O₂. More specifically, in many embodiments, the analysis cell is sealed using O₂-compatible O-ring seals and includes one inlet fitting and one outlet fitting for flowing analyzed gas through the sensor (FIG. 1B). For example, in many embodiments, silicone O-rings and dielectric coatings that are inert in O₂, such as SiO₂ and Al₂O₃ are utilized. In addition, in many embodiments, the analysis cell comprises the cell pressure sensor and the cell temperatures sensor, integrated with the analysis cell to enable simultaneous monitoring of the sample's conditions while in the analysis cell (FIGS. 5A and 5B). In many such embodiments, more specifically, the pressure sensor and the temperature sensors are a media-isolated pressure sensor with an integrated temperature sensor (FIGS. 5A and 5B); and the analysis cell further comprises two additional thermocouples embedded in the walls of the analysis cell near in the sample inlet and the sample outlet to monitor temperature within the analysis cell uniformly. In many embodiments, the cell pressure sensor comprises a protected temperature sensor.

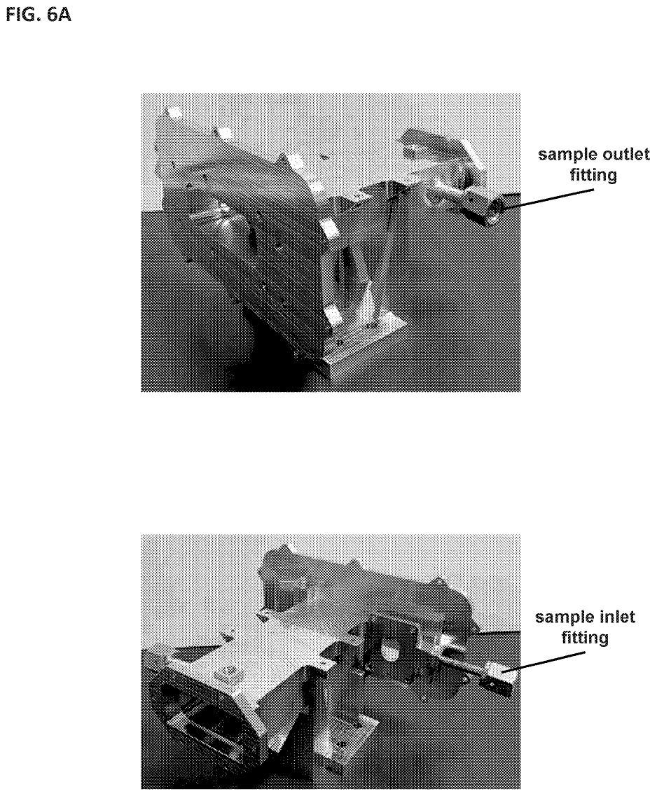

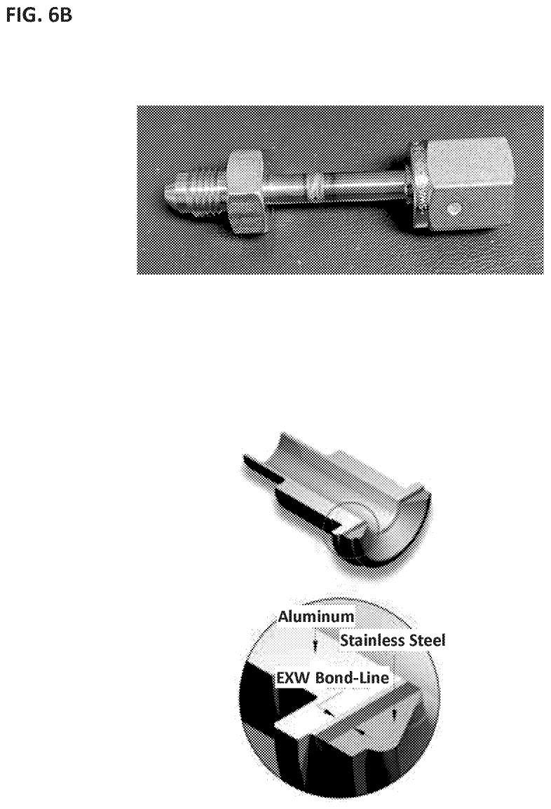

In many embodiments, the analysis cell comprises a single machined aluminum piece (FIG. 6A), the sample outlet fitting is a bi-metallic fitting gland, and the sample inlet fitting is a stainless steel gland welded to a stainless steel O-ring boss fitting (FIG. 6B), such that the sample outlet fitting is welded directly onto the analysis cell, and the sample inlet fitting is threaded into the analysis cell with a silicone O-ring seal (FIGS. 6A and 6B). In many embodiments, both the analysis cell (with the welded sample outlet gland) and the sample inlet fitting are cleaned of any particles prior to assembly to minimize particle-impact ignition hazards during subsequent operation in pure O₂ gas environment, including due to gas flow causing particle impacts.

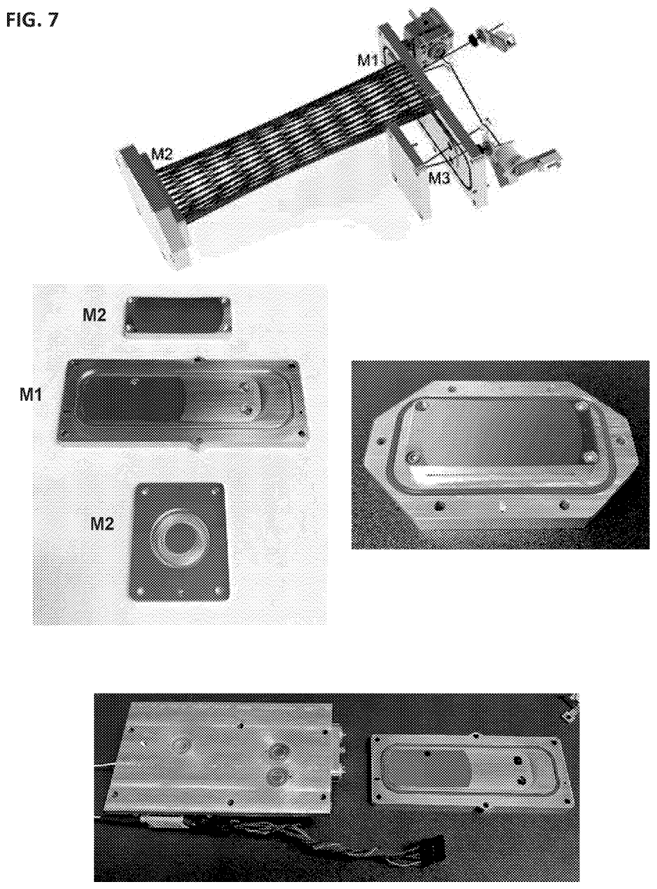

In many embodiments, the sensor relies on mirrors to form the long-pathlength and the short-pathlengths channels as illustrated in FIG. 7. In many embodiments, the mirrors are aluminum mirrors with diamond-turned surfaces and machined O-ring glands. In many embodiments, the mirrors are gold-coated with a protective SiO₂ layer. In particular, in many embodiments, the long-pathlength channel is formed using a pair of gold-coated mirrors with spherical curvature (M1 and M2, as seen in FIG. 7), manufactured by diamond turning of aluminum, wherein the near-side mirror includes a through-hole for both injection and extraction of the laser light. However, it should be noted here that, in many other embodiments, any number of mirrors are used, such as sufficient to form the desired optical channel pathlength for the laser emission as needed for a particular application of the sensor. In many such embodiments, the mirrors form a multi-pass (“long”) optical path in the Herriott cell configuration, with a total optical pathlength tuned for the first gas identity and the required sensitivity of an application. For example, in many embodiments, wherein the first gas is water vapor and the application requires a ppm sensitivity, the mirrors form a 62-pass optical path in the Herriott cell configuration, with a total optical pathlength of 9.6 m. In many such embodiments, the long-pathlength channel allows for 1 to 100 ppm (v) H₂O sensitivity. However, in many embodiments, the sensitivity of the long-pathlength channel is dependent on the absorption line being probed and the pathlength.

On the other hand, in many embodiments, the short-pathlength channel is formed by an angled two-pass configuration with a flat far mirror (M3 as seen in FIG. 7) and two separate sapphire wedge windows for input and output of the laser light. In many such embodiments, the thus formed “short” optical path also has a total optical pathlength tuned for the first gas identity and the required sensitivity of an application. For example, in many embodiments, wherein the application requires sensing of water vapor in oxygen gas with a wide sensitivity range of ppm to volume percents, the optical pathlength of the short-pathlength channel is approximately 6 cm. However, it should also be noted that, in many other embodiments, any number of mirrors and sapphire wedge windows are used, such as sufficient to form the desired optical channel pathlength for the laser emission as needed for a particular application of the sensor. In many such embodiments, the short-pathlength channel allows for 100 to 20,000 ppm (v) H₂O sensitivity. Notably, in many embodiments, M1 and M3 have no exposed fasteners within sealed region of the analysis cell volume, while M2 is attached to a flange with shims and stainless steel fasteners within the sealed region of the analysis cell.

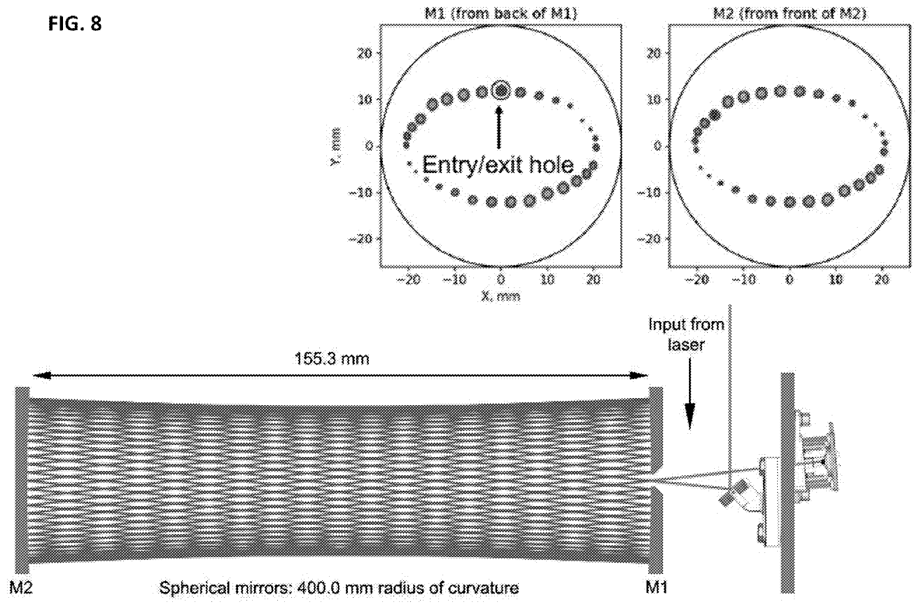

Furthermore, FIG. 8 illustrates the multi-pass Herriott cell optical configuration of many embodiments in greater detail. In particular, in many embodiments, the multi-pass Herriott cell optical configuration is designed to have a single entry and exit hole (FIG. 8). In many embodiments, the laser path of the multi-pass Herriott cell optical configuration is calculated using a custom Python raytracing script. In many embodiments, the multi-pass Herriott cell optical configuration is an elliptical Herriott cell design based on spherical mirrors with 62 passes (9.62 m total optical path length).

In many embodiments, the foreoptics compartment comprises a sealed and evacuated foreoptics volume to eliminate absorption outside the analysis cell (FIG. 5A). In many embodiments, the foreoptics volume is also isolated from the analysis cell (FIG. 5A). In many embodiments, the foreoptics volume is sealed from the analysis cell using O-ring seals on the sapphire wedge windows and the near-side mirror; and the foreoptics are also isolated from the external environment using a separate cover with an O-ring seal (FIG. 1B). Furthermore, in some embodiments, the isolated foreoptics volume is evacuated using an external vacuum pump through a single port in the foreoptics compartment cover (FIG. 5A). Notably, evacuating the foreoptics volume according to some such embodiments to a pressure of 10-5 atm or less results in negligible optical absorption from ambient water vapor.

In many embodiments, the foreoptics volume encloses the laser source, the beamsplitters, and the photodetectors (FIG. 1B). In many embodiments, the foreoptics compartment also comprises a foreoptics pressure sensor and a foreoptics temperature sensor (FIG. 5A). In many embodiments, the foreoptics compartment comprises thermistors embedded in the walls of the foreoptics compartment such that there is no contact between the thermistors and the sample (FIGa. 5A and 5B). In many embodiments, a Micro-Pirani pressure sensor is used to monitor foreoptics vacuum.

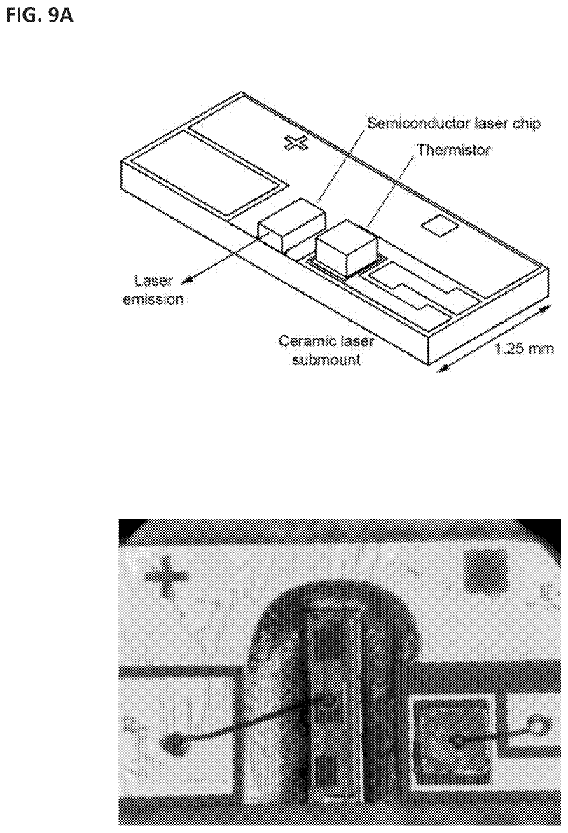

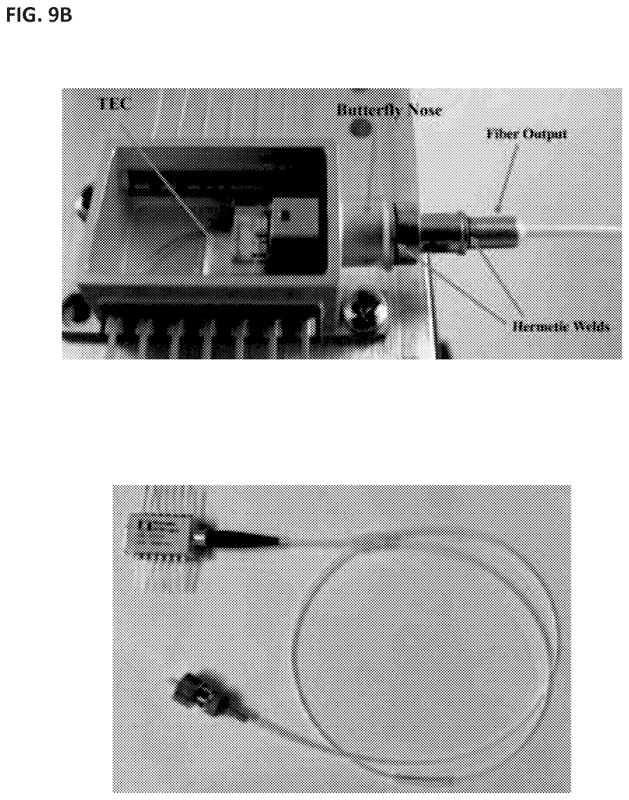

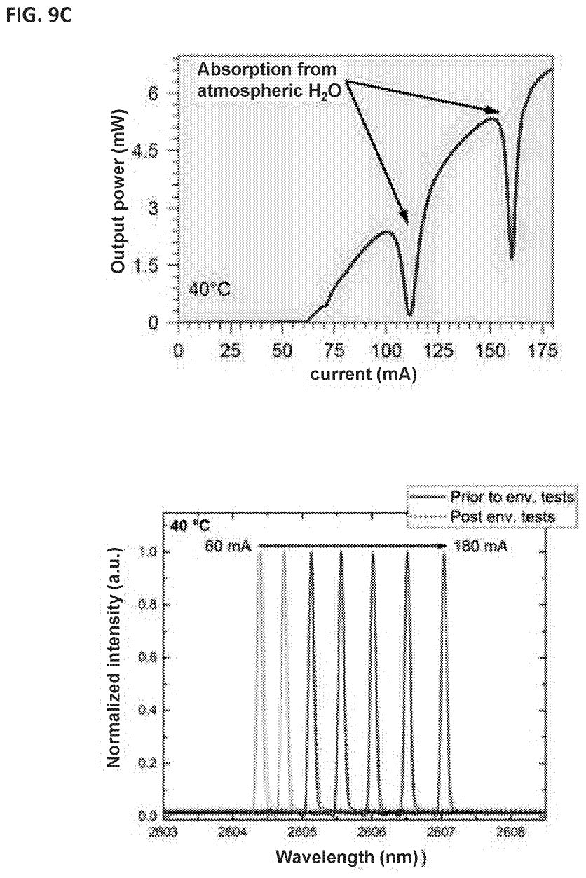

In many embodiments, the laser is a semiconductor laser, as illustrated in FIGS. 9A through 9C. In many embodiments, wherein the sensor is applied to detection of water vapor in oxygen, the laser in a 2.6 μm semiconductor laser. More specifically, in many embodiments, the laser is a custom distributed feedback laser. In many embodiments, the laser is packaged with fiber output and an integrated thermoelectric cooler (TEC). In many embodiments, the packaged laser passes component-level environmental testing prior to integration.

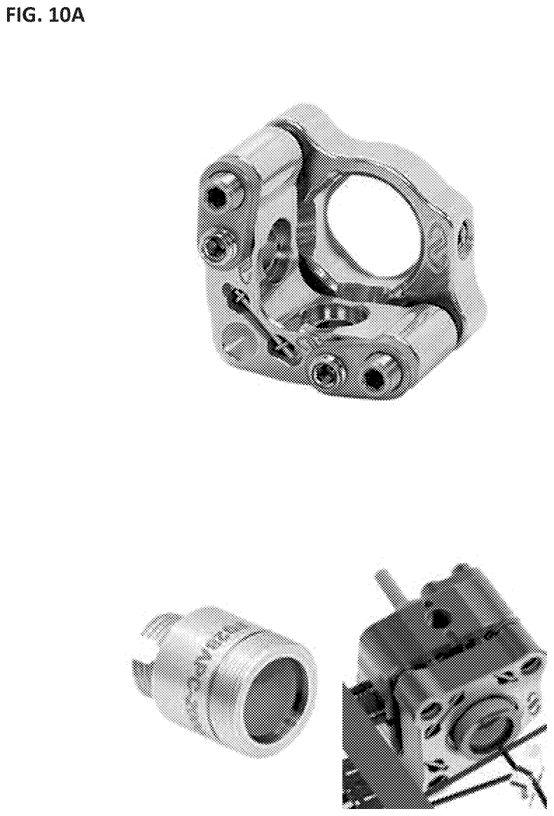

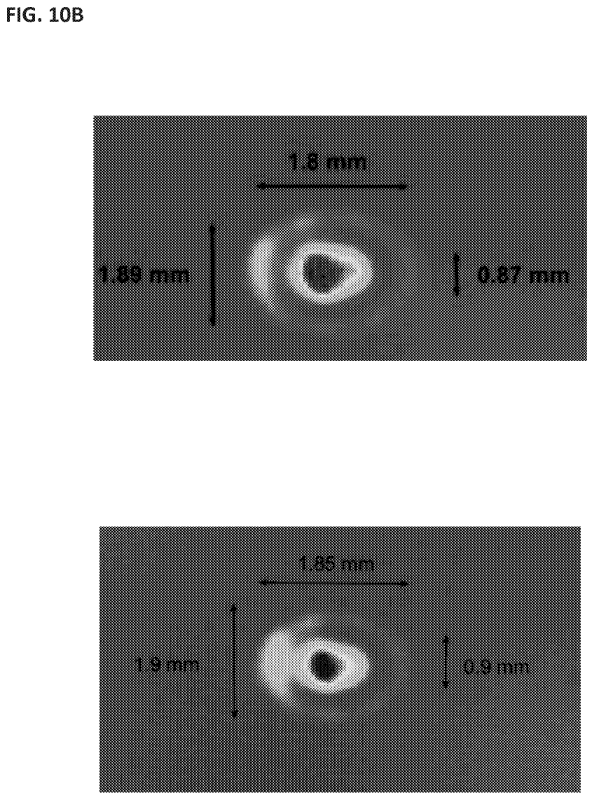

In many embodiments, the laser emission is transmitted from the inside of the laser package through the silica single-mode optical fiber to a laser collimator, all within the sealed foreoptics volume. In many embodiments, the laser collimator is an aspheric collimating lens (FIG. 10A). In many embodiments, optical surfaces of the laser collimator are coated with a low reflectivity coating, wherein the coating is selected such as to minimize back reflections at the chosen laser wavelength. For example, in many embodiments, especially wherein the sensor is used to detect water, the laser collimator is an off-the-shelf aspheric lens collimator coated for 0.2% reflectivity at 2.6 μm. In many embodiments, the laser collimator relies on a thermally compensated stainless steel two-axis kinematic mount for active alignment. For example, in some such embodiments, wherein the sensor is employed for water vapor detection in an oxygen gas supply during space and extraterrestrial exploration, the mount is manufactured for <5 prad) (0.0003° angular drift per 10° C. In many embodiments, the laser collimator affords a beam with an acceptable beam quality, as confirmable via the beam profiling with an infrared camera through environmental testing (FIG. 10B).

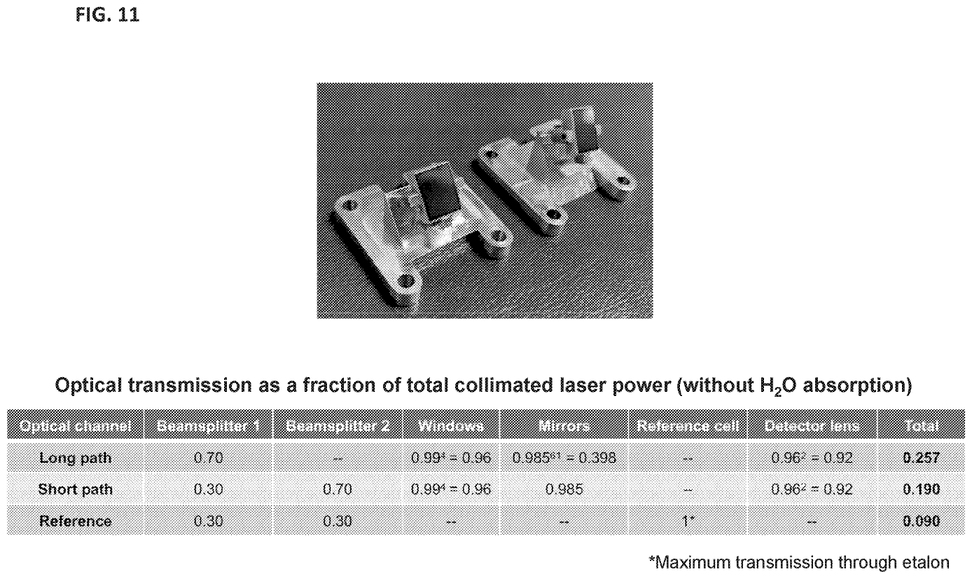

Furthermore, in many embodiments, the foreoptics compartment further comprises within the foreoptics volume the two beamsplitters used to reflect a fraction of the laser emission through the anti-reflective coated sapphire wedge windows and into the long- and short-pathlength optical channels of the analysis cell. More specifically, in many embodiments, the two beamsplitters are two ZnS beamsplitters (FIG. 11). In many embodiments, coatings and mounting angles of the beamsplitters are specifically designed and adjusted for the desired sensor application. For example, in many embodiments, the beamsplitter coatings are adjusted to tailor the amount of power in each of the optical channels (here, two analysis channels and one reference channel). As a more specific example, in many embodiments, the reflectivity of the first-surface (i.e., the surface of the beamsplitter closest to the laser source) is optimized for the optical system of the sensor. In many such embodiments, the optimization affords nearly equal power for analysis channels, with lower power for the reference channel.

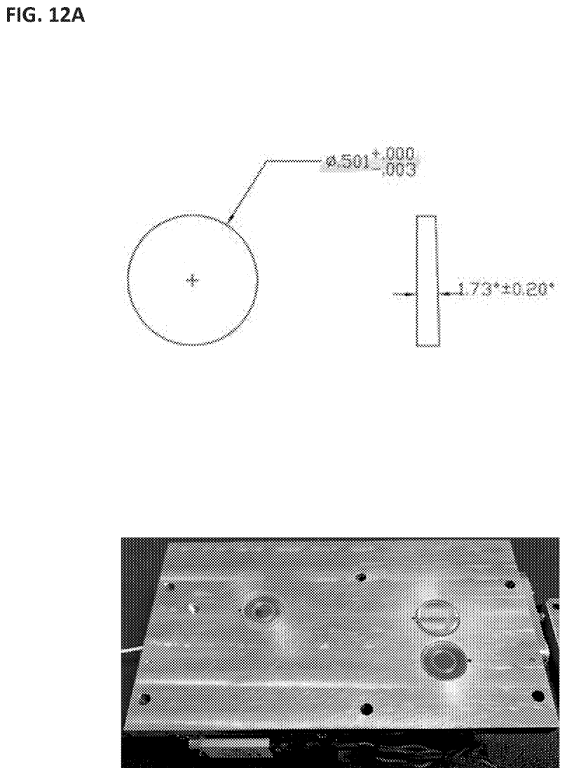

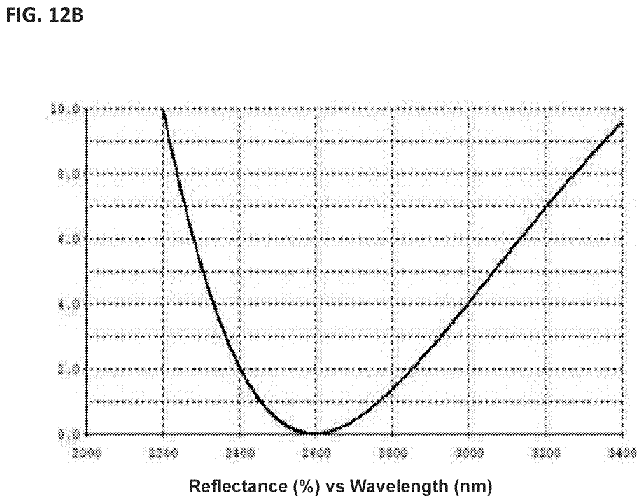

In many embodiments, at least one sapphire wedge window separates the analysis cell from the foreoptics volume, but allow the laser light to pass (FIGS. 1B and 12A). In many embodiments, the sensor comprises sufficient number of sapphire wedge windows to seal the analysis cell volume. For example, in some embodiments, the sensor comprises a single, sufficiently large for its intended function, window behind the mirror. However, in many other embodiments, the sensor comprises multiple smaller sapphire wedge windows as needed. In many embodiments, the sapphire wedge windows are coated with an antireflective (AR) coating (FIG. 12B). In many such embodiments, the AR coating comprises an outmost (i.e., exposed) layer comprising ZnSe. In many embodiments, the AR coating is customized for the laser wavelength. In many embodiments, the sapphire wedge windows comprise a polished c-plane sapphire, such as to withstand >100× expected pressure, as shown in Chervin, et al., Rev. Sci. Instrum., 65, 2719 (1994), the disclosure of which is incorporated herein by reference.

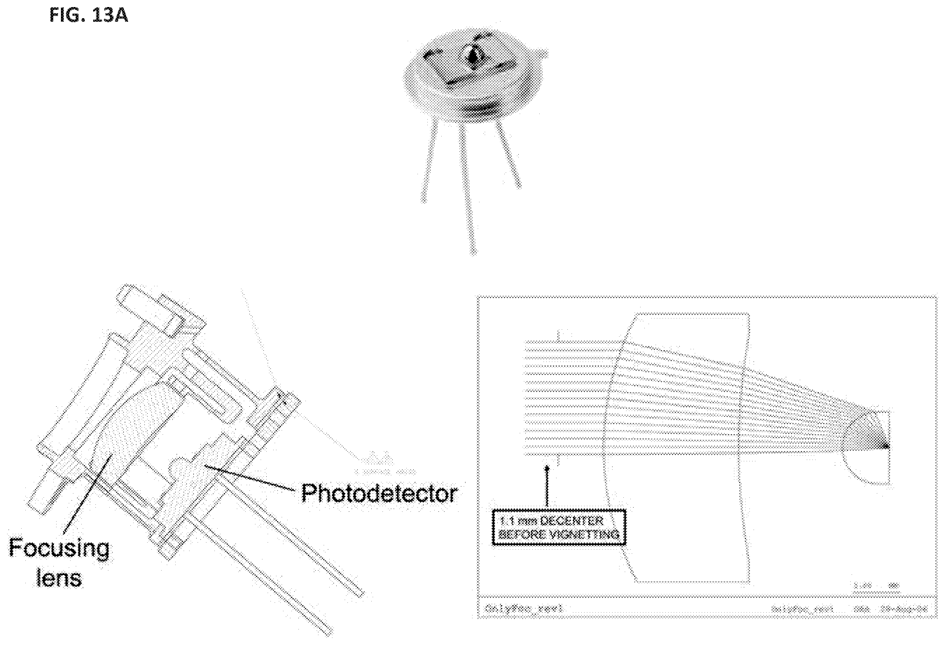

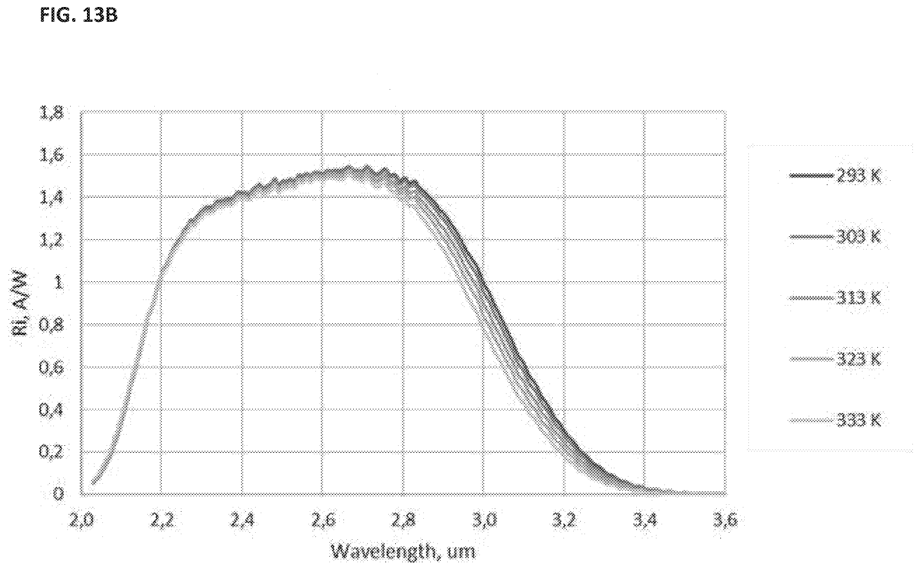

In addition, in many embodiments, three nominally identical photovoltaic detectors (photodetectors) are used to measure laser intensity for the long-pathlength, short-pathlength, and etalon reference channels (FIGS. 13A and 13B). In many embodiments, the photodetectors are photovoltaic HgCdTe detectors. In many embodiments, each of the three photodetectors is a HgCdTe photovoltaic detector with an immersion lens (FIG. 13A, top). In many such embodiments, the immersion lens is an integrated GaAs immersion lens that decreases alignment sensitivity for the photodetectors. In many embodiments, the HgCdTe photodetectors are uncooled. In many embodiments, the photodetectors offer an optimal responsivity at the laser wavelength (e.g., at 2.6 μm) with low temperature dependence. In other words, in many embodiments, the photodetectors have acceptable noise characteristics over the temperature range relevant to a particular application the sensor is used for.

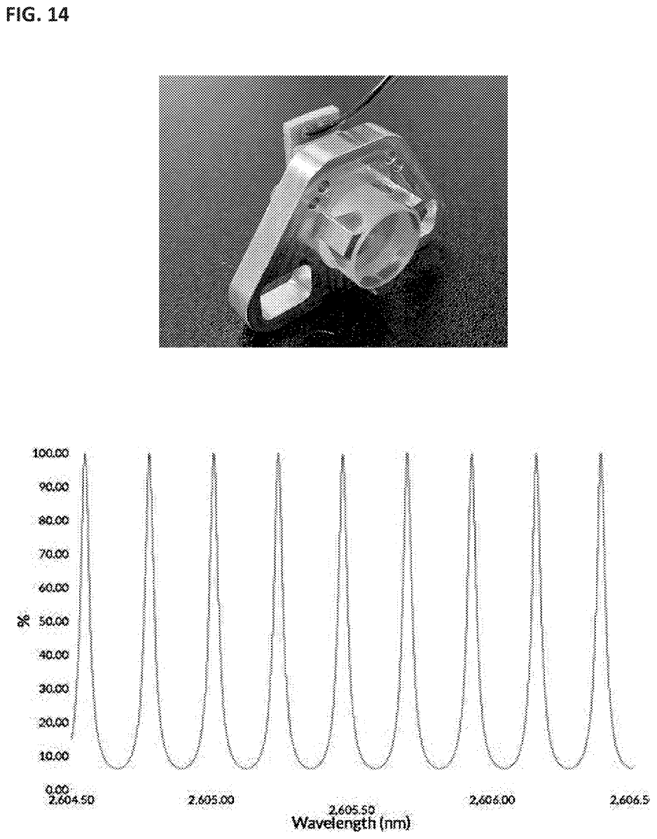

In addition, in many embodiments the laser light transmitted by the beamsplitters is aligned to the reference etalon situated within the foreoptics volume and used to characterize the laser wavelength tuning. In many such embodiments, the etalon is the Fabry-Perot etalon (FIG. 14). In many embodiments, the etalon is a silica etalon. More specifically, in many embodiments, the etalon is an IR-grade fused silica etalon with ~10 peaks across the laser tuning range, i.e., two or more distinct spectral features to establish a wavelength scale. It should be noted here that, an etalon design relying on a sealed N₂O gas reference cells was also tested but failed thermal cycling tests. In many embodiments, the etalon provides a relative measure of wavelength, such that the first absorption line (i.e., the target/probed absorption line, e.g., the primary water line), itself, is used by the sensor as an absolute reference. In many embodiments, the peak spacing for the etalon varies by <0.1% over the operating temperature range due to thermal expansion and thermo-optic effect, leading to <0.01 ppmv modeled error at 3 ppmv.

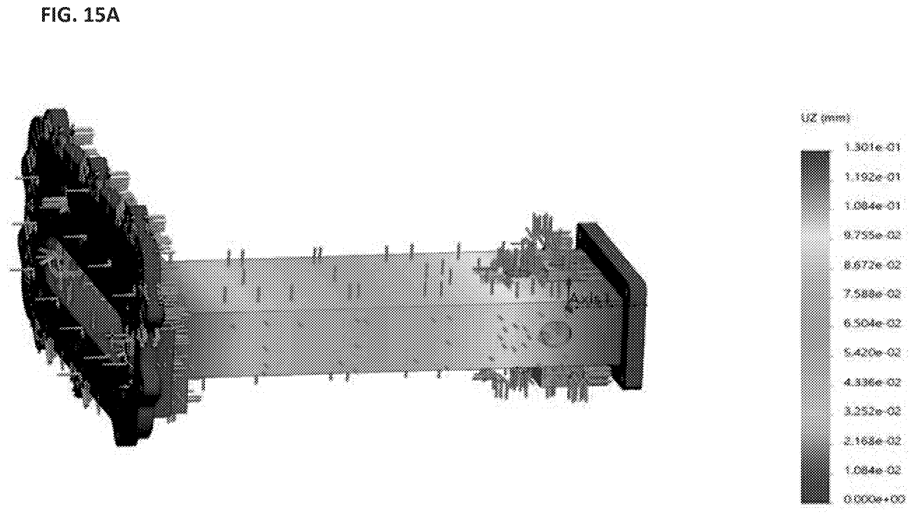

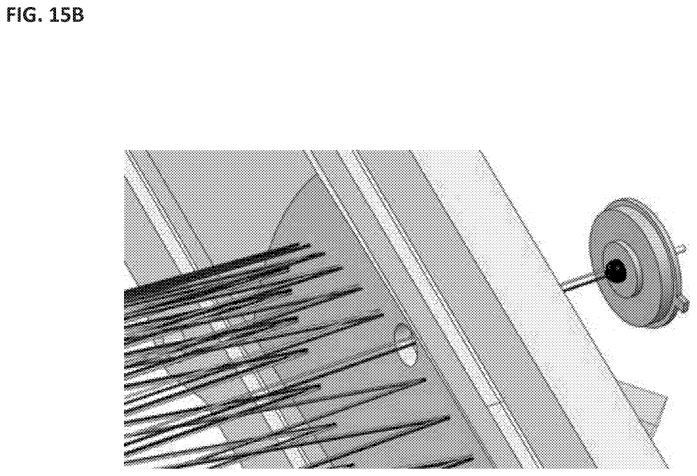

In addition, in many embodiments, the sensor and its components demonstrate excellent optomechanical tolerances. As one example, optomechanical tolerances of the sensor of many embodiments were analyzed with stochastic raytracing calculations, wherein combinations of the lateral beam displacement and the angular deviation were used to estimate the worst-case misalignment of the laser beam at the input to the long-pathlength channel/the Herriott cell (which is the most sensitive to misalignment optical channel of the sensor). To this end, 100 calculations with a normal distribution of displacements (0.2 mm stand. dev.) and angles (0.5° sand. dev.) in two-dimensions yielded an average beam displacement of 0.145±0.077 mm on the long-pathlength photodetector, indicating that the sensor design according to many embodiments allows to maintain laser beam alignment over the required temperature range of a given application. As another example, thermal effects on the optomechanical properties of the long-pathlength channel (the Herriott cell) of many embodiments were also considered. To this end, in many embodiments, a thermal expansion from 25 to 60° C. induces 0.13 mm elongation of the Herriott cell, and, as such, causes 0.54 mm displacement on the long-pathlength photodetector (FIGS. 15A and 15B), which is half of the maximum allowed with the photodetector collection lens (with a negligible effect on the short-pathlength and reference channels), indicating that, in many embodiments, the alignment is not temperature sensitive.

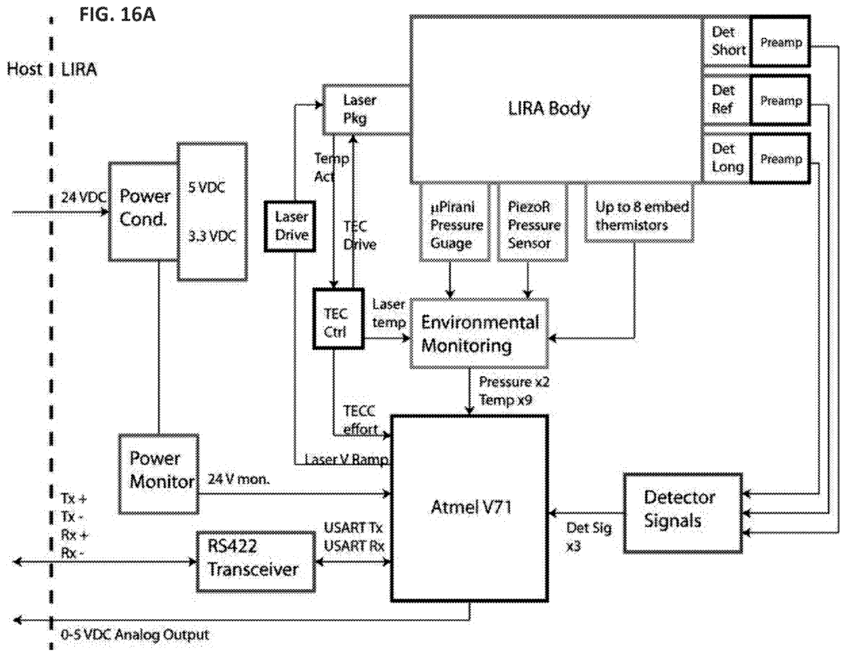

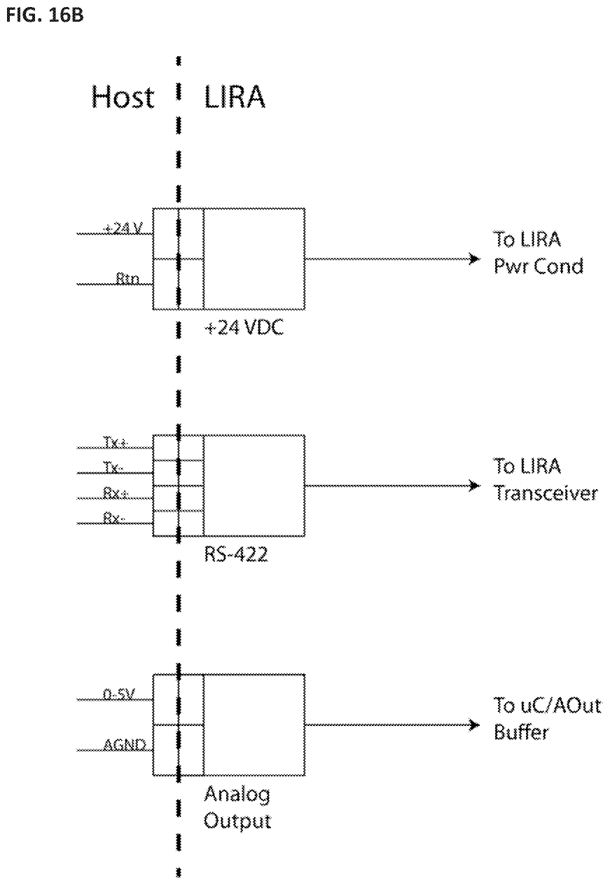

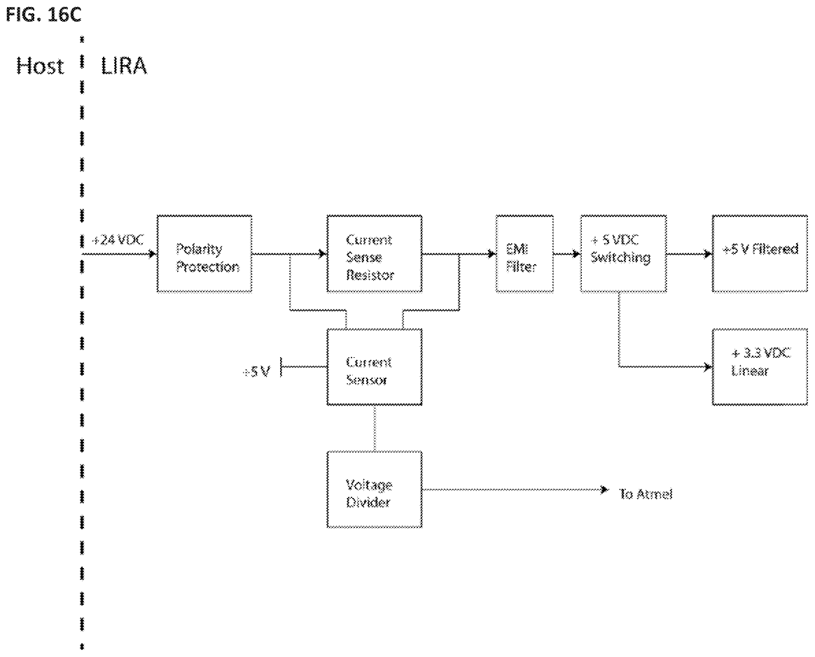

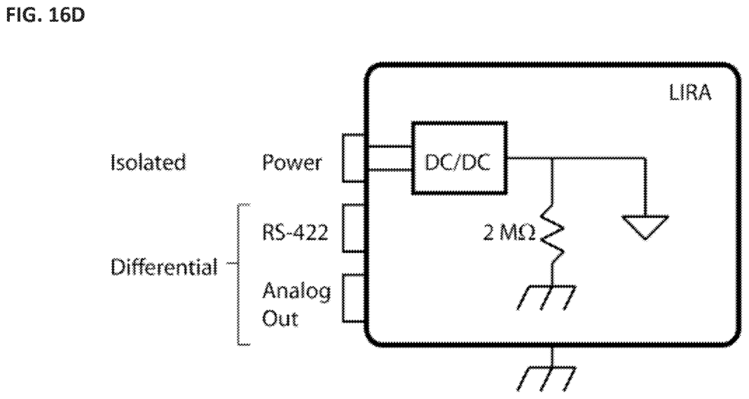

Moreover, in many embodiments, the sensor comprises the electronics housed within the electronics compartment (FIGS. 16A through 16D). The electronics of many embodiments comprise laser drive and photodetector amplification electronics. In many such embodiments, the laser drive and photodetector amplification electronics are controlled using a microcontroller. In addition, in many embodiments, a nonlinear fitting algorithm running on the microcontroller enables real-time fitting of the laser transmission spectra to determine a VMR for the first gas in the analysis cell (i.e., in the sample).

More specifically, in many embodiments, the electronics comprise control electronics for driving the laser, wherein the control electronics rely on components, comprising: a laser current driver module, a thermoelectric cooler controller, amplifiers for the photodetectors and pressure and temperature sensors, and a microcontroller for signal processing and data reduction (FIGS. 16A through 16D). In many embodiments, the LIRA instrument uses radiation-hard DC-DC converters from a single DC input voltage (FIG. 16D).

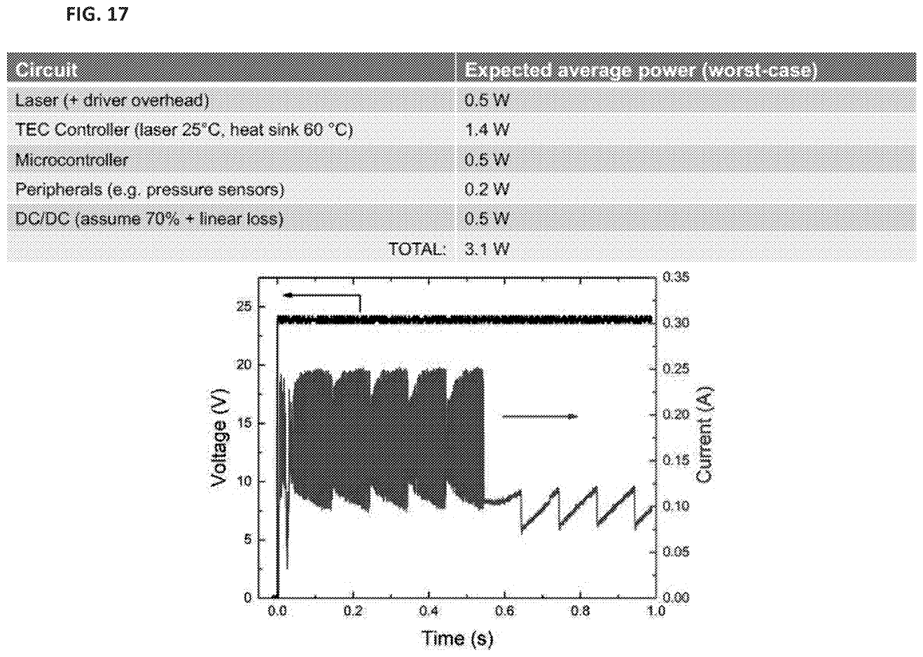

In addition, FIG. 17 provides an illustrative example of a power budget for the sensor of many embodiments and provides exemplary data for measured current at turn for the sensor. To this end, in many embodiments, power consumption is 2.2 W average in nominal conditions, wherein, in some embodiments, the nominal conditions comprise 90 mA at 24 VDC. In many embodiments, the maximum power requirement for the sensor is ~6 W at turn on (<1 s).

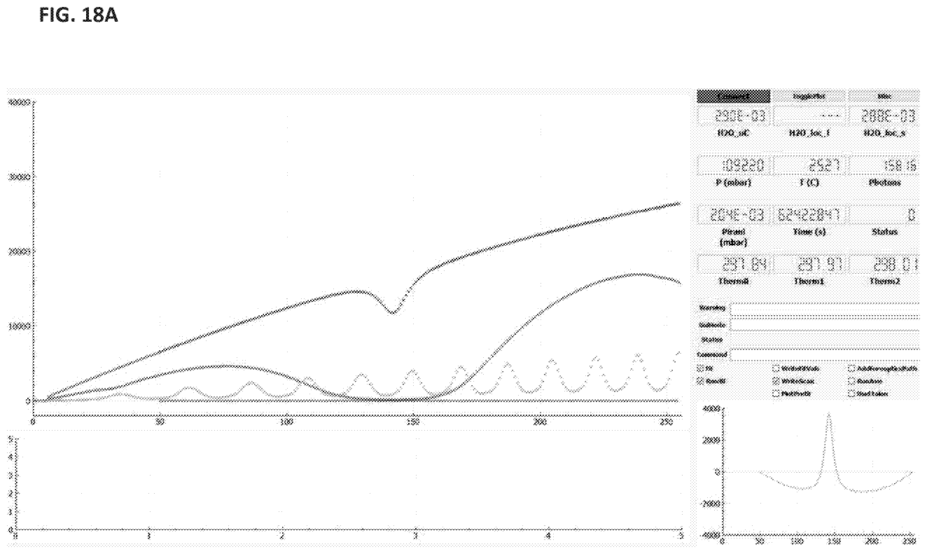

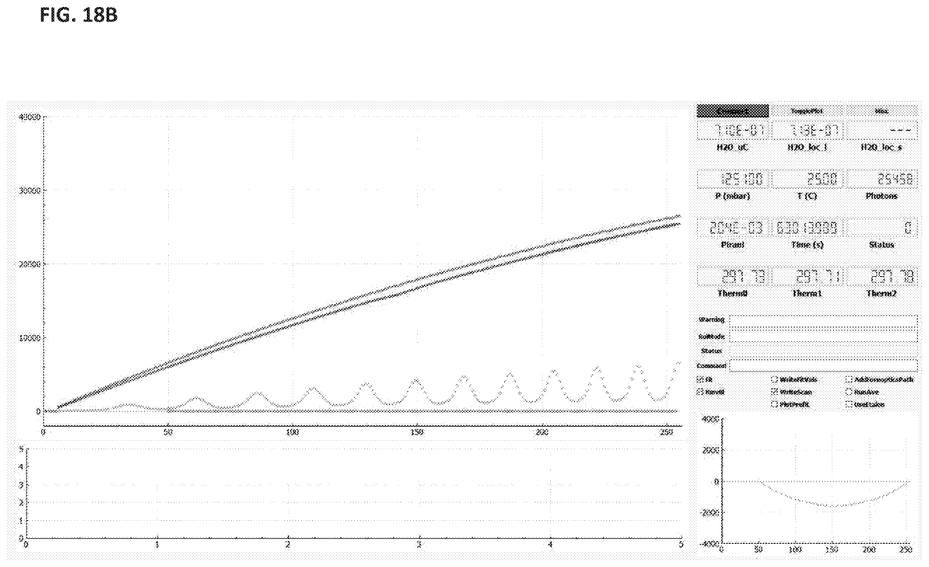

In many embodiments, the sensor affords data, wherein the data comprises: spectral data, pressure, temperature, and extracted VMR for the first gas within the sample. In many embodiments, the data is output on a digital serial line. In addition, in many embodiments, the VMR for the sample is also output as an analog voltage. For example, FIGS. 18A and 18B illustrate data afforded by the sensor for two samples analyzed according to many embodiments. More specifically, FIG. 18A provides the sensor's output for an air sample with moderate humidity, i.e., a sample of air with H₂O concentration of 0.3% by volume. On the other hand, FIG. 18B provides the sensor's output for a sample of laboratory grade nitrogen gas with very low humidity, i.e., a sample of N₂ with H₂O concentration of 0.7 ppmv. As can be seen from these figures, and according to many embodiments, the values displayed by the sensor comprise: the volume mixing ratio for the first gas (water in these examples) obtained from the measured absorption line; the cell pressure (P); the cell temperature (T); the foreoptics pressure (Pirani); the embedded thermistor readings (K); and other data and digitized spectra.

In many embodiments, the sensor is utilized for extraterrestrial applications. For example, in some embodiments, the sensor is used to analyze oxygen gas generated in situ from natural resources available on an extraterrestrial body, such as the Moon, prior to storing said oxygen cryogenically for later use as rocket propellant. More specifically, in many embodiments, the sensor is suitable for water detection in a lunar in situ resource utilization (ISRU) application, wherein the sensing requirements comprise detecting water at levels from saturated levels down to 1 part per million by volume (ppmv), at gas pressures ranging from 5 to 75 pounds per square inch absolute (psia), and at gas temperatures from 5 to 60° C.

However, in many embodiments, the sensor is utilized in terrestrial applications. For example, in many embodiments, the sensor is utilized in applications involving water measurements in pure O₂, including propellant analysis, and various water monitoring in other industrial processes.

In addition, in some embodiments, the sensor is adapted for measurements of other gases, rather than water vapor, made possible by modifications to laser wavelength. To this end, in many embodiments, the sensor is implemented to measure any of: CO, CO₂, CH₄, or another gaseous compound, in either terrestrial or extraterrestrial applications

### EXEMPLARY EMBODIMENTS

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., s or sec, second(s); min, minute(s); h or hr, hour(s); and the like.

### Example 1-Sensor's Performance

Multiple builds of the LIRA instrument have been assembled according to many embodiments described herein and tested at ambient conditions in air and using a low-humidity generator source with both air and pure N₂ carrier gas. Over a pressure range of 15 to 75 psia and a temperature range of 25 to 60° C., the tested LIRA instruments demonstrated a detection limit below 0.5 ppmv and accuracy better than ±0.3 ppmv at 1 ppmv and ±30% at higher water concentrations. It should be noted here that, although testing with pure O₂ has not been accomplished, analysis of measurements with N₂ and air (21% O₂ by volume) showed that the demonstrated here quantitative capability would not be degraded with 100% O₂.

In addition, an independent Oxygen Capability Assessment was completed, wherein the LIRA instrument of many embodiments was determined to be safe for pure O₂ operation within the specified temperature and pressure conditions, and with mass flow rate of 4 lb/h or less through the analysis cell.

### Example 2-Spectroscopy Modeling: Lower Detection Limit

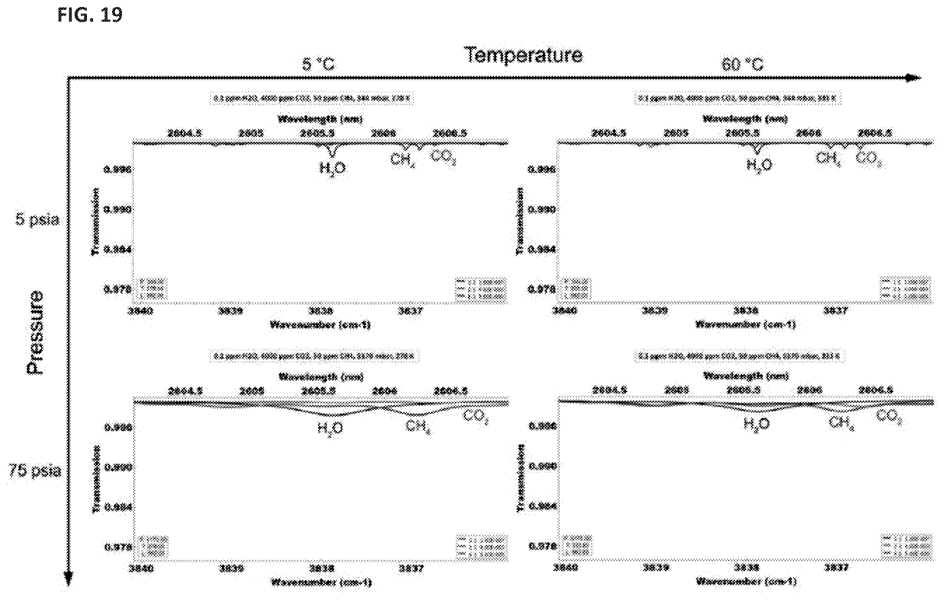

FIG. 19 provides data illustrating the lower detection limit of the sensor according to many embodiments. In these analysis experiments, water at 0.1 ppmv concentration within a sample of O₂ gas was detected across a pressure and temperature range.

### Example 3-LIRA Instrument Assembly

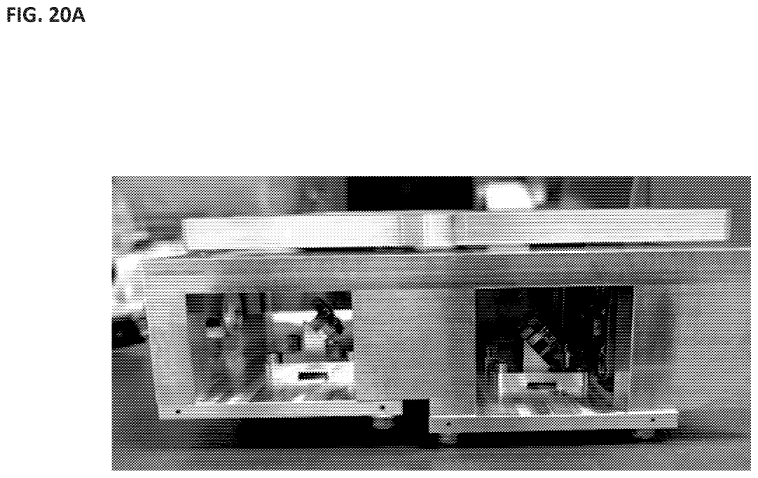

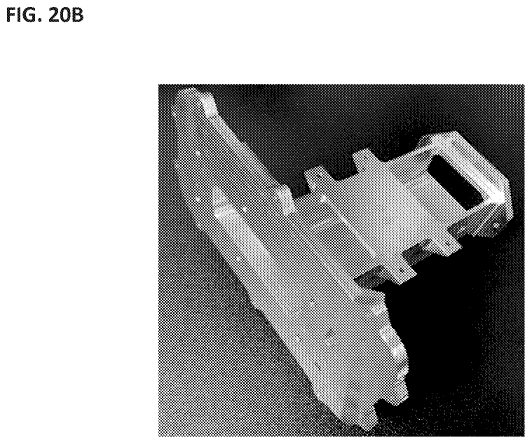

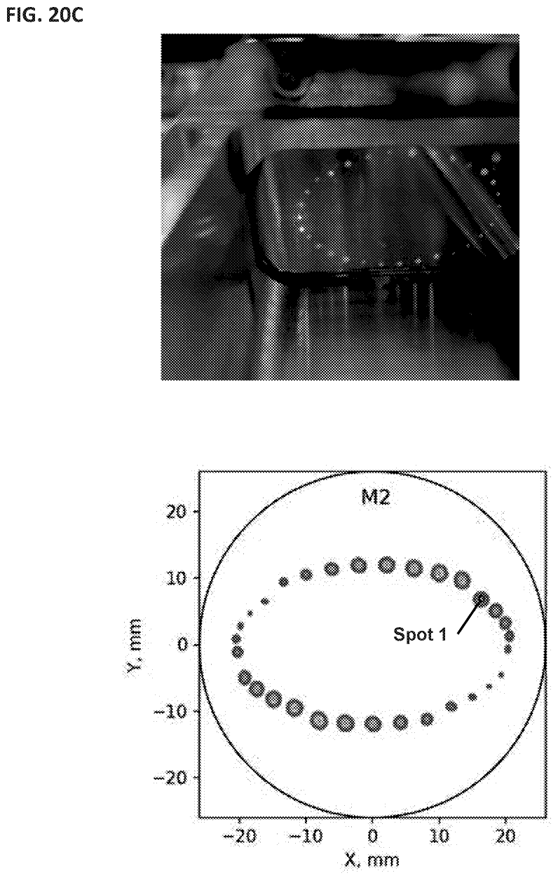

FIGS. 20A through 20C illustrate with photographs the component assembly and pre-alignment of many embodiments described herein. More specifically, in many embodiments, the sensor is assembled from machined metal parts that are cleaned to eliminate particle contamination that can create a combustion hazard in an O₂ environment, and the mirrors and other optical components that are delivered clean. In many embodiments, the foreoptics components are mounted using a suitable bonding agent (FIG. 20A). In many embodiments, the optomechanical system is assembled and pre-aligned with open alignment cell and red laser. In many embodiments, the optomechanical system is reassembled with the final analysis cell (FIG. 20B) and 2.6 μm laser. In many embodiments, the long-pathlength channel is aligned with red laser at pressure (FIG. 20C). In many embodiments, the short-pathlength and etalon channels are also aligned. In many embodiments, the laser temperature and detector gain values are adjusted for optimal throughput.

### Example 4-Final Alignment

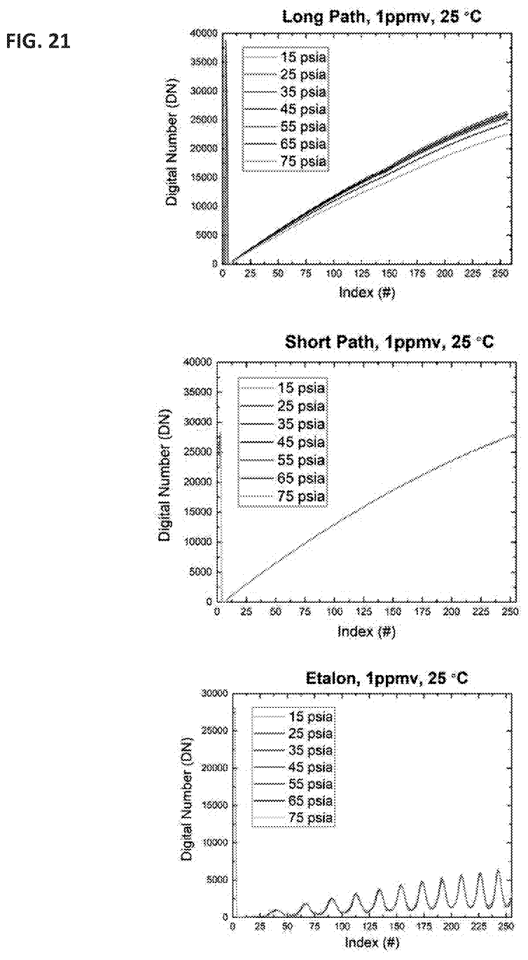

In many embodiments, the sensor undergoes a final alignment to correct for long-pathlength channel's pressure dependence, as the long-pathlength channel exhibits some pressure dependence, wherein calculations show negligible cell deformation from internal pressure. Although not to be bound by any theory, it is assumed that this pressure dependance is due to the sapphire wedge windows compressing their respective O-ring seals, which, in turn, leads to the laser beam displacement. Accordingly, in many embodiments, the sensor is aligned at an intermediate pressure, such that an acceptable throughput is achieved with a cell-to-foreoptics pressure differential ranging from 0 to 75 psi. Notably, and according to many embodiments, alignment drift for thermal variations up to 40° C. were found to be negligible, as were pressure variations for the short-pathlength and etalon channels. The data provided in FIG. 21 further demonstrates the pressure dependence of the channels.

### Example 5-Water Vapor in Laser Packages

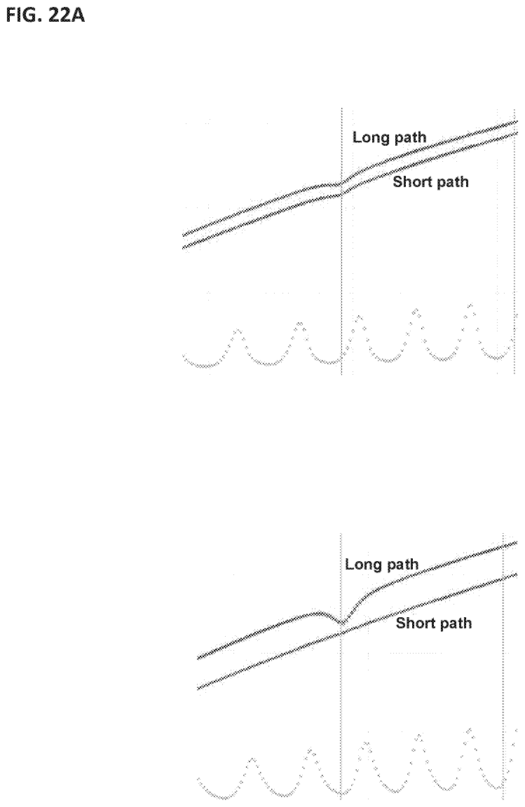

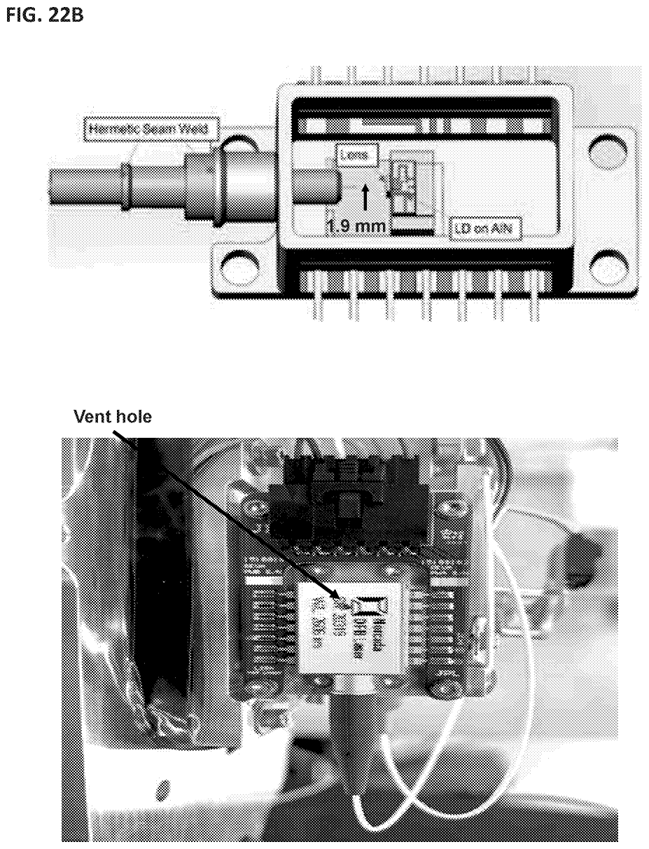

It should be noted here that it is possible for an as-packaged sealed laser package to have water inside. For example, FIG. 22A (top) shows absorption from water apparently inside the sealed laser package of an assembled LIRA instrument of many embodiments. In this example, with the foreoptics compartment evacuated and the analysis cell purged with N₂, according to many embodiments, there still was an implied 200 ppmv H₂O in the short-pathlength channel, consistent with ~0.6% H₂O in the laser package. However, carefully creating a vent hole in the laser package (as illustrated in FIG. 22B) enables the laser package to be evacuated with the foreoptics compartment and eliminates the issue (FIG. 22A, bottom).

### Example 6-Final Assembly

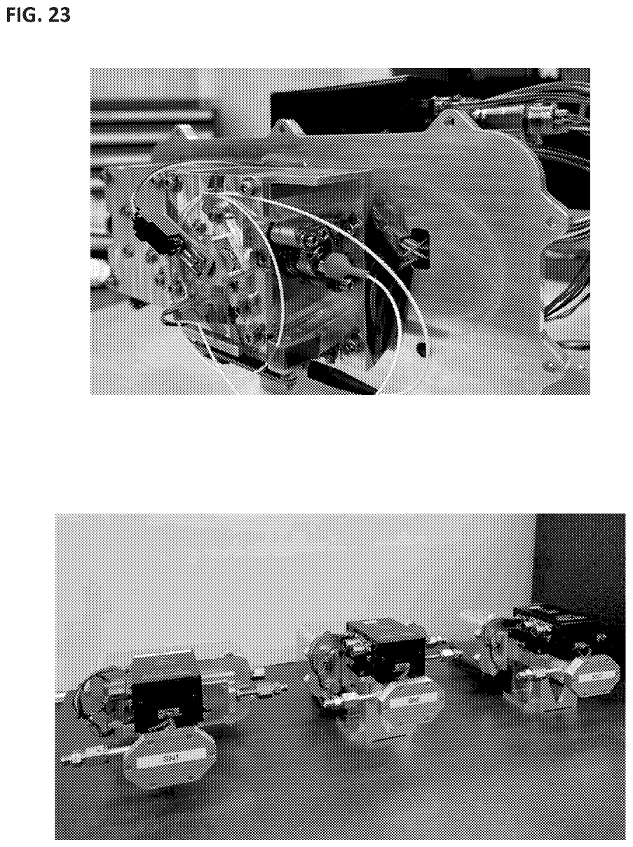

FIG. 23 provides photographs to illustrate the sensor at various stages of assembly, wherein the photograph on top shows the foreoptics compartment with staking epoxy following environmental testing, while the photograph on bottom shows several fully assembled LIRA instruments of many embodiments.

### Example 7-LIRA instrument Validation

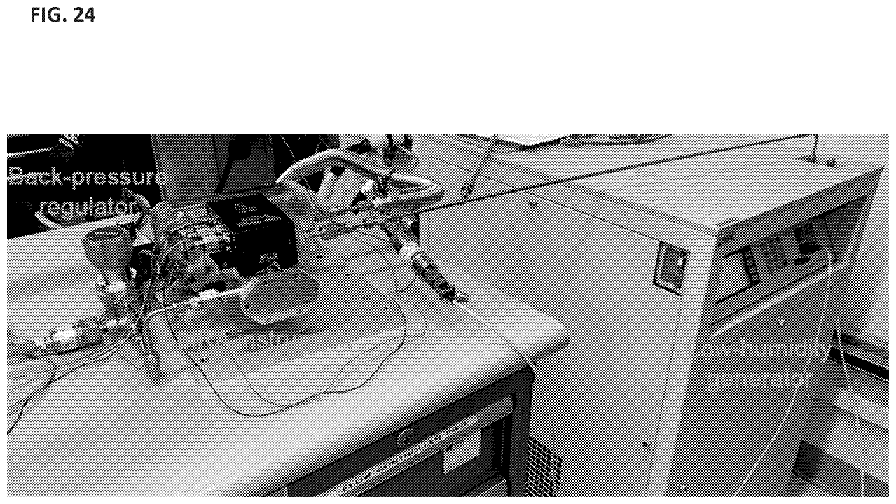

Thunder Scientific 3900 Low Humidity Generator was used to validate the sensor (FIG. 24) under conditions comprising:
0.05 to 12,000 ppmv H₂O range;
0.1 to 2.5 L/min flow, up to 75 psia;
accuracy based on internal pressure/temperature sensor calibration.

In these experiments, gas sources were cylinders of zero air and dry N₂ only, as Low Humidity Generator is not compatible with pure O₂. Furthermore, back-pressure regulators and a calibrated pressure gauge were used to vary pressure inside the analysis cell. In addition, heaters on gas supply line and the instrument body were used to control the temperature of the analysis cell.

### Example 8-Low Humidity Performance of the Sensor

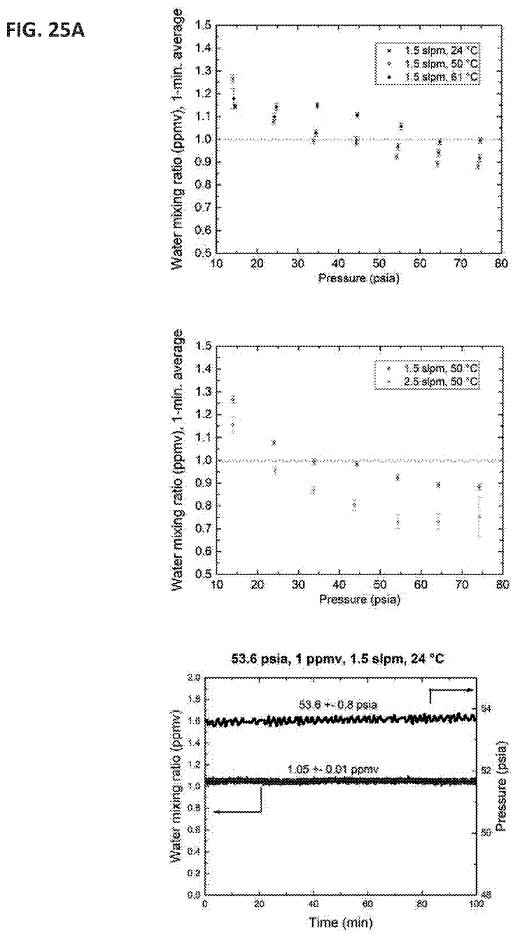

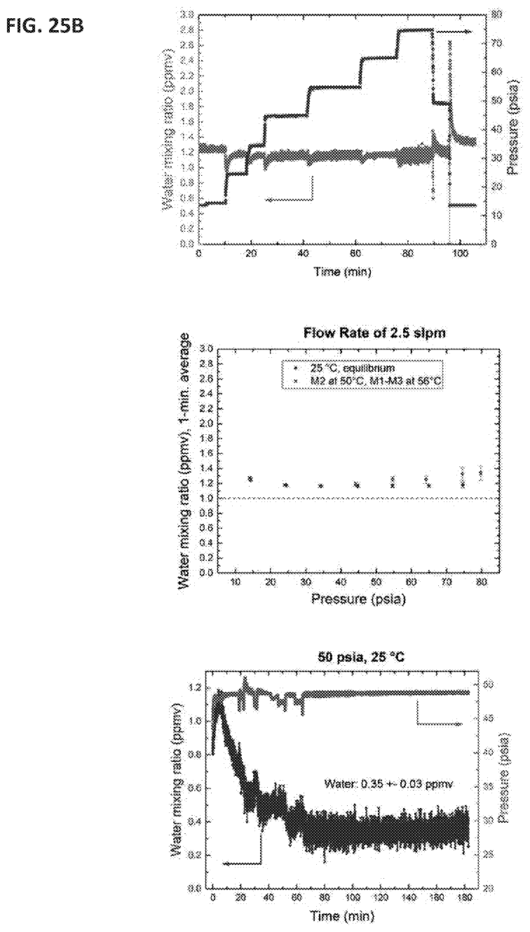

FIGS. 25A and 25B provide data collected with two distinct sensor of many embodiments to illustrate the low humidity performance of the sensor (i.e., the low limit sensitivity). More specifically, for both sensors the data was collected with a low humidity generator, as show in FIG. 24 stabilized at a controlled VMR of H₂O in air or N₂. Furthermore, FIG. 25A provides data collected by the sensor over the full pressure range of ambient to 75 psia, and temperature range from ambient to 60° C., which shows that the accuracy of the sensor was found to be better than 0.3 ppmv, while the precision was found to be better than 0.1 ppmv (1-minure measurement, 67% confidence interval). Moreover, the data provided in FIG. 25B shows comparable accuracy and precision for both models of the LIRA instrument. In addition, FIG. 25B demonstrates the absolute minimum detection measurement performed by the sensor at 0.15 ppmv setpoint on the low humidity generator (−85° C. frost point/−80° C. dew point), wherein the r lower limit of the generator was reached.

### Example 9-Dynamic Range and Analog Output

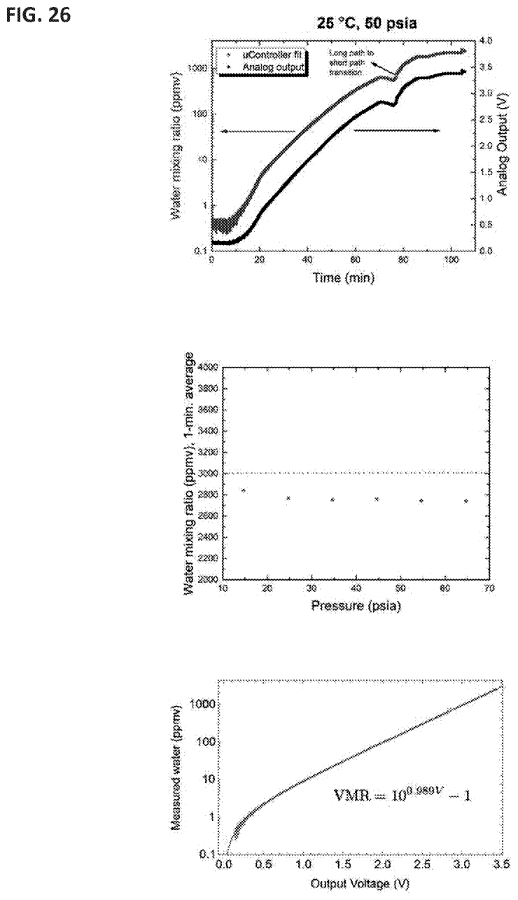

FIG. 26 provides data that further illustrates the dynamic range and analog output afforded by the sensor of many embodiments. This data shows that the dynamic range of the sensor is from 1 ppmv to at least 3,000 ppmv H₂O (0.3% by volume), with accuracy better than 30% of H₂O volume mixing ratio (VMR) and precision better than 10% of VMR. In addition, the data demonstrates that the analog output produces H₂O VMR from <0.1 ppmv to at least 10,000 ppmv. Furthermore, the switchover between the long- and short-pathlength channels occurs near 600 ppmv in ambient conditions (25° C., 1 atm).

### Example 10-Gas Composition Dependence

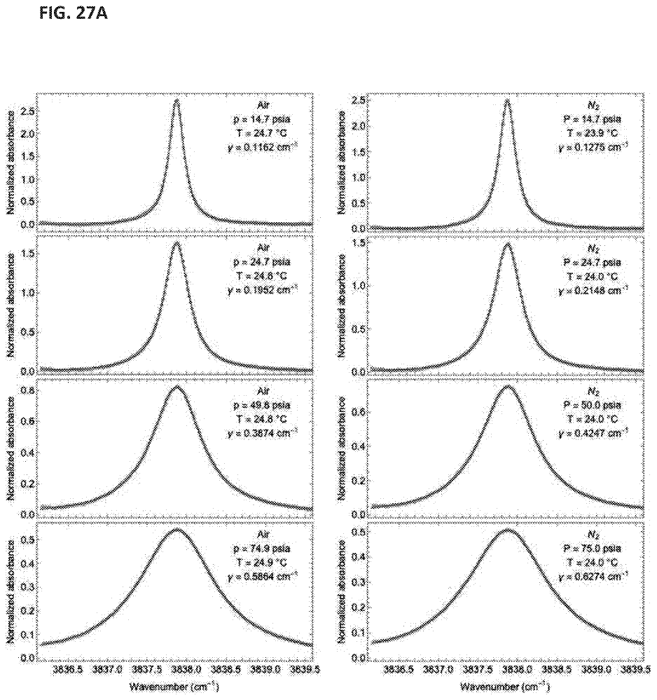

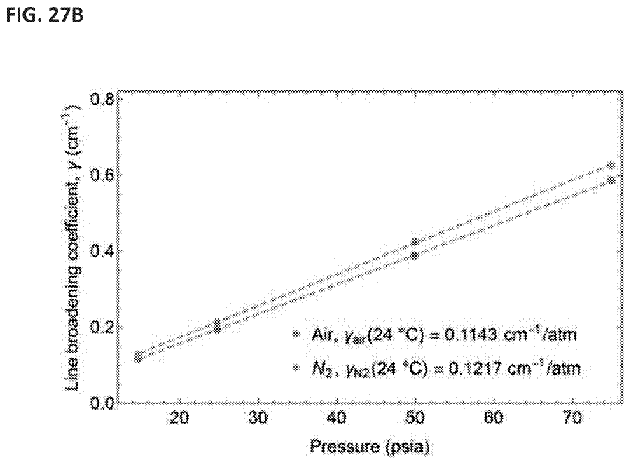

FIGS. 27A and 27B provide data illustrating the dependence of the sensor's performance on composition of the second (balance) gas, and, in particular, determination of O₂ broadening coefficient (γ_{O2}). To this end FIG. 27A shows absorbance spectra collected with 50 ppmv H₂O in air and N₂, while FIG. 27B shows dependence of line broadening coefficient on pressure. It should be noted here that HITRAN database lists air and self broadening coefficients. Furthermore, the total pressure broadening is a linear combination of component broadening, weighted by partial pressure, i.e.:

$$γ ( p , T = 296 K ) = {γ}_{a i r} ( p - {p}_{{H}_{2} O} ) + {γ}_{{H}_{2} O} {p}_{{H}_{2} O} \approx {γ}_{a i r} p$$

As such, since self broadening is negligible at 50 ppmv, measuring the air and N₂ broadening coefficients enables calculation of O₂ broadening coefficient:

$${γ}_{a i r} \approx 0.79 {γ}_{{N}_{2}} + 0.21 {γ}_{{O}_{2}}$$

Accordingly, O₂ broadening coefficient is Y_{O2}=0.0865 cm⁻¹/atm.

### Example 11-Effect of Broadening Coefficient

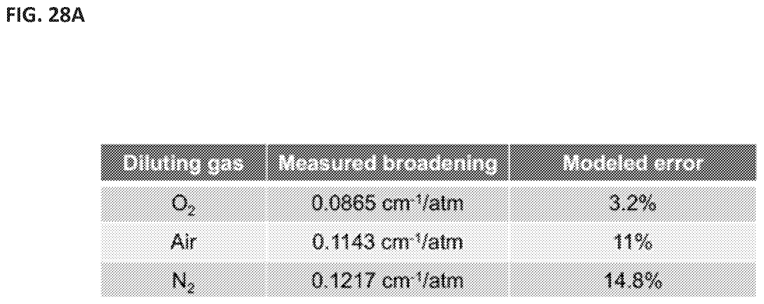

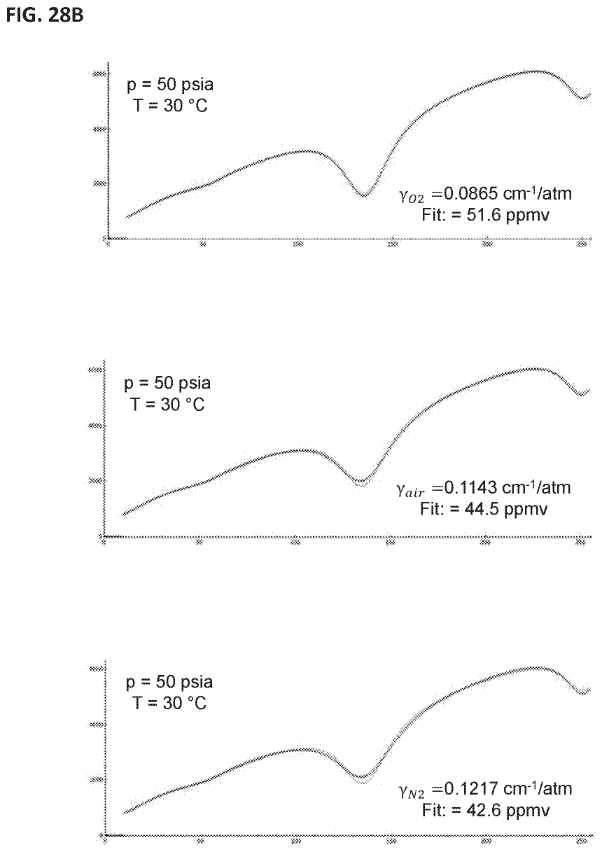

It should be noted here that HITRAN database air broadening coefficient is 0.0929 cm⁻¹/atm, wherein when using the HITRAN value for fitting, while modeling the measured coefficients for N₂, O₂, and air, the fitting error is within 20%. Furthermore, broadening coefficient is an adjustable parameter in the sensor's fitting algorithm and can be adjusted based on the composition of the tested gas. However, left at the nominal HITRAN value, the LIRA instruments will still meet performance requirements, illustrated by FIGS. 28A and 28B.

### Example 12-Oxygen Compatibility Assessment (OCA)

OCA of the sensor was performed, wherein all materials in contact with the sample gas were considered, including:
inlet/outlet fittings (stainless steel and aluminum);
aluminum analysis cell;
gold-coated aluminum mirrors;
coated sapphire wedge windows;
silicone O-ring seals;
pressure sensor.

It was found that, although flammable materials were present (i.e., aluminum and silicone), there was no ignition hazard determined within the expected pressure, temperature, and flow conditions, which included:
particle impact: prior testing showed no ignition of aluminum particles in 100% O₂ at 245 psig and 357 to 475 ft/s;
rapid pressurization: flow-through design (i.e., not a dead end design), so no ignition is expected with pressurization up to 275 psia;
flow friction: no ignition hazard at pressures below 500 psi.

### Doctrine of Equivalents

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A sensor for analyzing gas compositions comprising:
an analysis cell, characterized by a cell volume and further comprising:
a cell temperature sensor;
a cell pressure sensor;
a sample inlet, comprising a sample inlet fitting, for delivering a sample of a gas to be analyzed into the analysis cell; and
a sample outlet, comprising a sample outlet fitting, for flowing the sample of the gas out of the analysis cell;
a plurality of mirrors for forming optical channels;
at least one sapphire wedge window;
a foreoptics compartment, characterized by a foreoptics volume, wherein the foreoptics compartment is adjacent to, but is isolated from, including via the at least one sapphire wedge window, the analysis cell; wherein the foreoptics compartment further comprises:
a foreoptics temperature sensor;
a foreoptics pressure sensor; and
optical components, comprising:
a laser source,
a plurality of beamsplitters,
a plurality of photodetectors, and
a reference etalon;
wherein the foreoptics volume is sealed and evacuated, including isolated from the cell volume using O-ring seals on the at least one sapphire wedge windows and the plurality of mirrors; and
an electronics compartment comprising electronics, and further comprising control electronics;
such that, a laser emission, characterized by a laser wavelength, produced by the laser source is routed by the plurality of beam splitters and the plurality of mirrors through three optical channels: a long-pathlength channel and a short-pathlength channel within the analysis cell comprising the sample, and the reference etalon.

2. The sensor of claim 1, wherein the plurality of mirrors comprises three mirrors: M1, M2, and M3, such that M1 and M2 form the long-pathlength channel, while M3 forms the short-pathlength channel.

3. The sensor of claim 1, wherein the long-pathlength channel is of a multi-pass Herriott cell optical configuration.

4. The sensor of claim 3, wherein the long-pathlength channel is a 62-pass optical path in the Herriott cell configuration with a total optical pathlength of 9.6 m.

5. The sensor of claim 1, wherein the reference etalon is a reference selected from the group consisting of: a Fabry-Perot silica etalon and a sealed cell containing a known reference gas.

6. The sensor of claim 1, wherein the laser source is a tunable single-frequency semiconductor laser.

7. The sensor of claim 6, wherein the laser source is a 2.6 μm-wavelength laser.

8. A method for analyzing gas compositions comprising:
providing a sensor comprising:
an analysis cell, characterized by a cell volume and further comprising:
a cell temperature sensor;
a cell pressure sensor;
a sample inlet, comprising a sample inlet fitting, for delivering a sample of a gas to be analyzed into the analysis cell; and
a sample outlet, comprising a sample outlet fitting, for flowing the sample of the gas out of the analysis cell;
a plurality of mirrors for forming optical channels;
at least one sapphire wedge window;
a foreoptics compartment, characterized by a foreoptics volume, wherein the foreoptics compartment is adjacent to, but is isolate from, including via the at least one sapphire wedge window, the analysis cell; wherein the foreoptics compartment further comprises:
a foreoptics temperature sensor;
a foreoptics pressure sensor; and
optical components, comprising:
a laser source,
a plurality of beamsplitters,
a plurality of photodetectors, and
a reference etalon;
wherein the foreoptics volume is sealed and evacuated, including isolated from the cell volume using O-ring seals on the at least one sapphire wedge window and the plurality of mirrors; and
an electronics compartment comprising electronics, and further comprising control electronics;
such that, a laser emission, characterized by a laser wavelength, produced by the laser source is routed by the plurality of beam splitters and the plurality of mirrors through three optical channels: a long-pathlength channel and a short-pathlength channel within the analysis cell comprising the sample, and the reference etalon;
providing the sample comprising a second gas to be analyzed for a presence and a concentration of a first gas, wherein the first gas is characterized by a first absorption line, and flowing the sample into the analysis cell;
propagating the laser emission, wherein the laser wavelength is adjusted to probe the first absorption line, through the three optical channels to profile the sample for the first absorption line
to determine a volume mixing ratio for the first gas in the sample.

9. The method of claim 8, wherein the first gas is a molecule selected from the group consisting of: H₂O, CO, CO₂, CH₄, and another gaseous compound with a known absorption line or lines.

10. The method of claim 8, wherein the second gas is N₂ or O₂.

11. The method of claim 8, wherein the plurality of mirrors comprises three mirrors: M1, M2, and M3, such that M1 and M2 form the long-pathlength channel, while M3 forms the short-pathlength channel.

12. The method of claim 8, wherein the long-pathlength channel is of a multi-pass Herriott cell optical configuration.

13. The method of claim 12, wherein the first gas is H₂O, the second gas is O₂, and the long-pathlength channel is a 62-pass optical path in the Herriott cell configuration with a total optical pathlength of 9.6 m.

14. The method of claim 8, wherein the laser source is a tunable single-frequency semiconductor laser.

15. The method of claim 14, wherein the first gas is H₂O and the laser wavelength is a 2.6 μm.

16. The method of claim 8, wherein the reference etalon is a reference selected from the group consisting of: a Fabry-Perot silica etalon and a sealed cell containing a known reference gas.
